(19) United States
(12) Patent Application Publication
(10) Pub. No.: US 2016/0029253 A1
(43) Pub. Date: Jan. 28, 2016

(54) SYSTEM AND METHOD OF AUTOMATIC NEIGHBOR RELATION (ANR) INTELLIGENCE ENHANCEMENT FOR BOOMER NEIGHBOR IN LTE

(71) Applicant: TELEFONAKTIEBOLAGET L M ERICSSON (PUBL), Stockholm (SE)

(72) Inventors: Debasish Sarkar, Irvine, CA (US); Ayan Sen, Gurgaon (IN)

(21) Appl. No.: 14/444,621

(22) Filed: Jul. 28, 2014

(51) Int. Cl. H04W 36/00

(52) U.S. Cl. CPC H04W 36/0016

(57) ABSTRACT

A system and method to automatically classify a target cell as a boomer cell for a source cell to assist the source cell in adding or rejecting the target cell as a valid neighbor of the source cell. Such classification is based on the distance between the source and target cells, and the tier value indicating the number of layers of cell sites between the source and target cells. A Self Organizing Network-Optimization Manager, SON-OM, server provides the distance and tier information and, for neighbors which are already defined and existing in a source cell's neighbor list, the SON-OM server can perform a validation—based on corresponding distance and tier calculations—whether these neighbors are boomer cells or not. A boomer cell can be automatically eliminated from the neighbor list and all handovers to that boomer cell can be prevented to improve interference management and resource utilization in the network.

### TECHNICAL FIELD

The present disclosure generally relates to the Automatic Neighbor Relation (ANR) functionality in wireless communication systems. More particularly, and not by way of limitation, particular embodiments of the present disclosure are directed to a system and method that uses a Self Organizing Network (SON) Application Server (AS) to automatically classify a target cell as a boomer cell based on its distance and tier value in relation to a source cell and to exclude such boomer cells from having a neighbor relation in a neighbor list of the source cell created using the ANR procedure.

### BACKGROUND

In cellular communication, the most basic form of “handover” or “handoff” is when a phone call in progress is redirected from its current cell (called “source cell” or “serving cell”) to a new cell (called “target cell”). In terrestrial cellular radio networks, the source and the target cells may be served from two different cell sites or from a single cell site (in the latter case, the two cells are usually referred to as two “sectors” on that cell site). Such a handover (HO), in which the source and the target cells are different cells (even if they are on the same cell site) is called an inter-cell handover. The purpose of an inter-cell handover is to maintain the call as the subscriber is moving out of the area covered by the source cell and entering the area of the target cell.

One of the most time-consuming tasks in today's cellular networks is the optimization of handover relations. The Automatic Neighbor Relation (ANR) feature in Third Generation Partnership Project's (3GPP) Long Term Evolution (LTE) networks minimizes the need for the manual configuration of a neighbor cell list (also referred to as a “neighbor list” or Neighbor Relations Table (NRT)) for intra-frequency or inter-frequency handovers. ANR automatically builds up and maintains a neighbor list or NRT used for handover. ANR adds neighbor relations to the serving cell's neighbor list when certain measurement reports by a User Equipment (UE) in an LTE network indicate that a possible new neighbor relationship has been identified. When this occurs, the serving evolved Node B (eNB or eNodeB) or Radio Base Station (RBS, or more simply “BS”) requests the UE to report the unique Cell Global Identity (CGI) of the potential neighbor cell. Using this information, the serving RBS/eNB automatically creates a neighbor relation between the serving cell and the new neighbor cell using the ANR procedure, thereby facilitating UE's handover to that neighbor cell. The ANR feature can be used together with manual optimization of neighbor lists, and ANR is also able to automatically remove neighbor cell relations which have not been used within a particular time period.

FIG. 1 illustrates an existing operational sequence as part of an Automatic Neighbor Relation (ANR) procedure in LTE to build a neighbor list (or NRT) at a serving cell 10 in a wireless system 12 for facilitating a future handover. For the sake of simplicity, only two cells—the serving cell 10 and a neighboring cell 14—are shown in FIG. 1 as part of the wireless system 12. It is understood that many such cells may form part of the system 12, and inter-cell handovers among those cells allow a UE (e.g., the UE 16) to “seamlessly” continue mobile communication throughout the system 12 and beyond. As mentioned earlier, the cells 10 and 14 may be part of different cell sites (not shown) or may belong to the same cell site (not shown). Furthermore, although cells 10 and 14 are illustrated far apart in FIG. 1 and although UE 16 is shown outside of both of these cells 10, 14, such illustration is for the sake of convenience and ease of discussion only. In the context of the handover related discussion with reference to FIG. 1, it is understood that the UE 16 may be physically present and operating (or registered) within the serving cell 10 or may be currently associated with—i.e., under Radio Frequency (RF) coverage of—or attached to the serving cell 10 in some manner (e.g., through prior handover), but may need to be handed over to the neighboring/adjacent cell 14 if so determined by the eNB 18 associated with the serving cell 10 and providing RF coverage to the UE 16 within the serving cell 10. A different eNB 20 may be associated with the neighboring cell 14 to provide RF coverage over cell 14 and in its vicinity. In LTE, the communication interface between the serving eNB 18 and the neighboring eNB 20 is called the “X2” interface, which may be used to carry out necessary HO-related signaling. The X2 communication interface between two eNBs 18, 20 is symbolically illustrated by dotted line 22. In the discussion below, the serving cell 10 may be interchangeably referred to as “Cell A” whereas the neighboring cell 14 may be interchangeably referred to as “Cell B.”

As shown in FIG. 1, the wireless system 12 may also include a Core Network (CN) 24 through which the eNBs 18, 20 may communicate with an Operations Support System 26. The OSS 26 may be an OSS for Radio and Core (OSS-RC). Although not shown explicitly, it is noted here that each eNB 18, 20 may be connected to the CN 24 and the OSS 26. Furthermore, the OSS 26 also may be connected to the CN 24 and may provide a proprietary (network operator-specific) platform for supervision, configuration, deployment and optimization of a mobile or cellular network (e.g., the wireless system 12), with features tailored to promote efficient working procedures in daily network operations. The OSS 26 may provide full support for management of fault, performance, and network configuration, and may also provide a number of new applications that may be used in the trouble-shooting and network optimization stages. The CN 24 may be an Evolved Packet Core (EPC) in LTE. In FIG. 1, the block showing the CN 24 is shown dotted to indicate lack of any appreciable involvement of the CN 24 (or its component nodes) during the ANR procedure or subsequent handover operation.

The OSS 26 may be implemented using a combination of hardware and/or software modules. Some exemplary modules in the OSS 26 are shown in FIG. 1. As illustrated, the OSS 26 may include, among others, a Domain Name Server (DNS) module 28, an OSS-RC Network Resource Model (ONRM) 30, and a Performance Management Support (PMS) module 32. As mentioned below, the DNS module 28 may store and provide on request Internet Protocol (IP) address of a cell or other related information for the cell in the wireless system 12. The ONRM module 30 may store data and messages (e.g., alarm or non-alarm messages) from various network elements or nodes (e.g., an eNB or RBS, or a node in the core network) in the wireless system 12 and make its content available to other OSS modules or system components (not shown) for efficient management of network performance and handling of fault events. The PMS module 32 may provide an interface (e.g., a Graphical User Interface or GUI) to manage performance of various network elements or nodes such as, for example, an RBS, a Radio Network Controller (RNC), a node in the core network, etc., in the wireless system 12. The PMS module 32 may allow a network operator or other authorized third party to set up and administer collection of performance management data from different portions (e.g., a Radio Access Network (RAN) portion) of the overall cellular network (e.g., an LTE network).

Just as an example, the UE 16 may be considered to be handed over from the serving cell (Cell A) 10 to the target cell (Cell B) 14. It is understood that similar handover may be performed from Cell B to Cell A (or between any other pair of cells in the system 12), when necessary. For ease of discussion, only the handover from Cell A to Cell B is addressed here. The operational sequence—performed prior to the handover—for building a neighbor list (not shown) at the serving cell 10 using the ANR procedure is illustrated using arrows or other indicators associated with reference numerals 35 through 41.

FIG. 2 shows a flowchart 43 that provides details of each operation or step in the operational sequence 35-41 illustrated in FIG. 1. Thus, for the sake of convenience and ease of understanding, identical reference numerals are used in FIGS. 1 and 2 for the operational sequence 35-41, and FIGS. 1 and 2 are jointly discussed below to explain what steps are performed to build a neighbor list at the serving cell 10 using ANR. It is assumed here that the Physical Cell ID (PCI) of Cell A has been assigned a value of “3”, whereas the PCI of Cell B has been assigned a value of “5” as shown in FIG. 1. Similarly, it is also assumed that the Cell Global Identity (CGI) for Cell A has a value of “17,” whereas the CGI for Cell B has been assigned a value of “19.”

As is known, when the UE 16 is mobile, it may start receiving RF signals from the eNB 20 in the neighboring cell 14 along with the RF signals from its serving cell 10, especially when the UE 16 is in the vicinity of the neighboring cell 14. The eNB 18 for the serving cell 10 may have an ANR function, as a result of which the eNB 18 may instruct each UE (such as the UE 16) attached to the serving cell 10 and under operative control of the eNB 18 to perform measurements on the neighboring cells. The eNB 18 may use different policies for instructing the UE 16 to do the measurements and when to report them to the eNB 18. An exemplary sequence of operations associated with ANR's handling of a neighbor relation for the serving eNB 18 may be as under:
1. The UE 16 may periodically perform Downlink (DL) radio channel measurements based on the Reference Symbols (RS). When the UE 16 receives RF signals from the neighboring cell (i.e., Cell B) 14, the UE 16 may report Cell B's signal measurements (as received by UE 16) to Cell A (as shown by arrow 35 in FIG. 1 and block 35 in FIG. 2). The UE 16 may perform measurement on the neighbor cells, such as the cell B, by measuring their Reference Symbols Received Power (RSRP) and Reference Symbols Received Quality (RSRQ). If certain network-configured thresholds are satisfied for these RSRP and RSRQ values for Cell B, the UE 16 may detect PCI of Cell B by decoding Primary Synchronization Signal (PSS) and Secondary Synchronization Signal (SSS) values associated with Cell B.
2. As noted above, the UE 16 may send its measurement report regarding Cell B to Cell A as indicated by arrow 35 in FIG. 1 and block 35 in FIG. 2. Such measurement report may contain Cell B's PCI, but may not contain Cell B's CGI or EUTRAN Cell Global Identity (ECGI) (which is also sometimes referred to in the literature as the Extended Cell Global Identity), as applicable. The term “EUTRAN” refers to the Evolved Universal Terrestrial Radio Access Network (EUTRAN) air interface in LTE. It is noted here that in case of an EUTRAN in LTE, the term “CGI” may be replaced with the term “ECGI”. In any event, the terms “CGI” and “ECGI” may be interchangeably used hereinbelow, and the mention of one term and absence of the other in the relevant discussion below should not be construed to mean that the discussion does not apply to the non-mentioned term. In other words, reference to “CGI” also includes “ECGI” (if applicable), and vice versa.
3. Assuming Cell B is not on Cell A's current neighbor list, when Cell A receives PCI=5 (i.e., the PCI of Cell B) from the UE 16, Cell A may conclude that this PCI value is not known. Then, Cell A may instruct the UE 16 to read, using this newly-discovered PCI as a parameter, the CGI or ECGI for Cell B, the Tracking Area Code (TAC) of Cell B, and all the Public Land Mobile Network Identities (PLMN IDs) of the available cells of the related neighbor Cell B. This operation is shown by arrow 36 in FIG. 1 and block 36 in FIG. 2. The ECGI information for Cell B may include the Public Land Mobile Network Identity (PLMN ID) for Cell B, the Closed Subscriber Group (CSG) indicator for Cell B, and the Cell ID for Cell B. To receive the information requested at block 36 in FIG. 2, the eNB 18 may need to schedule appropriate idle periods in the DL to allow the UE 16 to read the ECGI from the broadcast channel of the detected neighbor Cell B.
4. In response, the UE 16 may read and decode the System Information (SI) broadcasted for Cell B to find out Cell B's ECGI. The UE 16 may then report that ECGI to the serving Cell A (as shown by arrows 37 in FIG. 1 and block 37 in FIG. 2). As noted before, this ECGI information for Cell B may include Cell B's PLMN ID, CSG Indicator, and cell identity. In addition, the UE 16 may also read and report at step 37 the TAC of Cell B and all the PLMN IDs that have been detected as being associated with Cell B.
5. Upon receiving Cell B's CGI or ECGI (as applicable), Cell A may decide to automatically add this neighbor relation to its neighbor list using ANR and may use Cell B's PCI and the ECGI to look up a transport layer address to the new eNB 20 as indicated by arrow 38 in FIG. 1 and block 38 in FIG. 2. More particularly, as part of the look-up procedure at block 38, the serving eNB 18 may check if X2 (i.e., communication interface) to the eNB 20 in Cell B is allowed. For example, there may be an X2 Setup List 44 stored in the ONRM 30. The setup list 44 may include an “X2 Black List” and an “X2 White List,” and may also include details of date and time of ANR creation and ANR modification as part of a software Managed Object (MO) representing the eNB or EB 18 as shown by block 45 in FIG. 1. In block 45, the “anrCreated” entry indicates whether the MO has been created by the ANR function, the “timeOfAnrCreation” entry indicates the date and time when the MO was created by the ANR function, the “timeOfAnrModification” entry indicates the date and time when the MO was last modified by the ANR function, and the “ctrlMode” entry indicates permission to change attributes on the MO and to delete the MO. The “ctrlMode” entry can be set to “Manual” (where the operator can chance and delete the MO, but the ANR function cannot make changes) or “Auto” (where the ANR function can change and delete the MO, but the operator cannot). Thus, the parameters in block 45 characterize the ANR Creation aspect, while those in the block 44 indicate the permissions associated with the ANR neighbors. If the target cell—i.e., Cell B 14—is not present in the earlier-mentioned “Black List” (at block 44), then the eNB 18 of the source cell 10 would assume that X2 to that target cell is allowed. If X2 with Cell B is allowed, Cell A may use Cell B's CGI/ECGI to get the transport layer address—here, the IP address—for Cell B from the DNS module 28 in the OSS 26 via DNS or S1 Configuration Transfer (as shown by arrow 39 in FIG. 1 and block 39 in FIG. 2). As is understood, in LTE, the eNB 18 may communicate with the all-IP core network 24 via an “S1” interface.
6. Upon receiving Cell B's IP address, Cell A may automatically add (using ANR) Cell B as a neighbor cell in its neighbor list. If needed, the source eNB 18 may then setup a new X2 interface to the eNB 20 as indicated by arrow 40 in FIG. 1 and block 40 in FIG. 2. After X2 is established with Cell B, the eNB 18 in Cell A may update its neighbor relation list and may also update OSS 26 with relevant observation data (as indicated by arrow 41 in FIG. 1 and block 41 in FIG. 2). Cell B's presence in Cell A's neighbor list would then allow Cell A to execute subsequent handover to Cell B, when needed. The “observation data” may include all the configuration information needed to setup the handover from Cell A (i.e., eNB 18) to Cell B (i.e., eNB 20). Updating the OSS 26 with this data may help all future handovers (from Cell A to Cell B) because the system now has all the information needed for a future handover request and it need not ask the UEs to read ECGI information (for Cell B) every time (e.g., as indicated at block 36 in FIG. 2). In one embodiment, the “observation data” may include, for example, the IP address for the other (target) cell, the PCI for the target cell or sector (the serving cell and the target cell may be referred to as “sectors” when they both belong to the same cell site), etc.

The operational sequence 35-41 discussed above is part of the ANR procedure at the serving cell (i.e., Cell A) 10. Upon conclusion of the operational sequence 34-41, eNB 18 in Cell A may perform handover of UE 16 to eNB 20 in Cell B when certain network-specified triggers for HO are present.

### SUMMARY

ANR is a feature that can automatically add or remove neighbor relations based on historical use of statistics on OSS. For example, in the context of FIG. 1, if OSS statistics indicates that no handovers are being performed to Cell B by Cell A, then the ANR functionality in the eNB 18 may remove Cell A's neighbor relation with Cell B. In that case, the sequence of operations discussed with reference to FIGS. 1-2 may repeat at some later point in time to again add Cell B as Cell A's neighbor such as, for example, when another UE reports Cell B to Cell A after Cell A has removed its neighbor relation with Cell B. However, the ANR functionality does not perform a check to verify whether the new neighbor cell reported by a UE is a “boomer cell” before adding it as a valid neighbor through ANR function. For example, a boomer cell can be provided by a UE to its serving cell as a viable candidate to be added as a neighbor of that serving cell. However, the ANR function in the serving cell does not have any information as to whether the new cell provided by the UE is a boomer cell. This can result in a scenario where unintended cells (or serving nodes) may be added as “neighbors”, leading to sub-optimal resource utilization and poor interference management.

FIG. 3 is an exemplary illustration depicting the concept of a “boomer cell”. In FIG. 3, for ease of illustration, only the base stations are shown without corresponding cell sites or cells. In the exemplary arrangement of FIG. 3, a source cell—as represented through a source eNB 45—is shown along with six neighboring cells, each of which is represented by the corresponding base station or eNB 46 through 51. In the discussion herein, the same reference numeral is used to refer to a base station as well as its associated cell. A “boomer cell” may be defined as an overshooting cell which provides RF coverage to an area beyond its designed coverage area. Thus, as shown in FIG. 3, the remote cell 46 may qualify as a “boomer cell” in relation to the source cell 45 because its designed coverage 53 overextends to and overlaps with the coverage from cell 45, thereby creating an unintended coverage area 54 in the vicinity of the source cell 45. This unintentional coverage from the boomer cell 46 may create excessive Uplink (UL) interference—e.g., for UEs attached to the source cell 45—because of high transmission power required from the UEs operating in the unintended coverage area and attached to the boomer cell 46 to communicate with the remote (boomer) cell 46. The unintentional coverage also may create wastage of valuable cell resources because it would require the eNB 46 in the boomer cell to cater to UE traffic from far off areas beyond its designated coverage area.

It is seen from the above that if boomer cells are not managed properly, they may create problems when a network is upgraded or a new network is deployed. For example, at a later stage of network deployment, new cells may come up intermittently. If the old boomer cells/neighbors are not properly optimized physically such as, for example, through tilt adjustment of a boomer cell's antenna(s) to contain the boomer cell's radio coverage within a designated area, then these overshooting neighbors (i.e., boomer cells) may continue to thrive in the neighbor list of a new cell that is recently deployed in the network. Thus, even with availability of automatic neighbor relation management through the ANR functionality, a network operator must still manage the boomer cells using traditional methods of optimizing the network. One such traditional method is the manual tilt adjustment of a boomer cell's antenna(s) to “refocus” the cell's coverage within a designated region to avoid the problem of overshooting or unintentional coverage.

It is therefore desirable to improve the ANR functionality to automatically check whether a new neighbor cell reported by a UE is a “boomer cell” before adding it as a valid neighbor through ANR function. If the cell is determined to be a boomer cell, it is desirable to reject it as a neighbor. It is also desirable to automatically validate those neighbors that are already defined and existing to identify boomer cells in those neighbors as well.

Particular embodiments of the present disclosure provide for a system and method to automatically classify a neighbor cell as a boomer cell. In one embodiment, the ANR system at a source cell may be improved to make a decision whether to add or reject a target cell suggested by a UE as a valid neighbor of the source cell. Such decision may be based on (i) the distance between the source and the target cells, and (ii) the tier value indicating the number of layers of cell sites between the source and the target cells. In one embodiment, the distance and tier information may be provided by a Self Organizing Network (SON) Application Server (AS) to automatically classify a target cell as a boomer cell and to exclude such boomer cells from a neighbor list (or NRT) of a source cell created using the ANR procedure. Thus, information necessary to recognize a particular candidate cell as a boomer cell is automatically provided using SON practices.

For neighbors which are already defined and existing in a source cell's neighbor list, a SON-Optimization Manager (SON-OM) server can perform a validation whether these neighbors are overshooting or not. Such validation may be based on the above-mentioned distance and tier calculation as well as on correlation with Timing Alignment (TA) values and Power Headroom Report (PHR) criteria. Accordingly, the boomer cells can be flagged for deletion and suitable physical optimization. Thus, once a neighbor cell is classified as a boomer cell, it can be automatically eliminated from the neighbor list without the manual intervention of the operator.

In one embodiment, the present disclosure is directed to a method of classifying a target cell to determine whether a User Equipment (UE) associated with a source cell is to be handed off to the target cell by an evolved Node B (eNB) in a wireless system, wherein the eNB provides Radio Frequency (RF) coverage to the UE associated with the source cell. The method comprises performing the following using the eNB: (i) first determining that the target cell is not defined as a neighbor of the source cell in a Neighbor Relations Table (NRT) of the source cell; (ii) in response to the first determining that the target cell is not defined in the NRT of the source cell, querying a Self Organizing Network-Optimization Manager (SON-OM) server to provide information about a distance between the source cell and the target cell and a tier value indicating a number of layers of cell sites between the source cell and the target cell; (iii) receiving the distance and the tier value information from the SON-OM server; (iv) second determining that the distance is greater than a first threshold and the tier value is greater than a second threshold; and (v) classifying the target cell as a boomer cell in response to the second determining.

In another embodiment, the present disclosure is directed to a network entity in a cellular network for classifying a target cell to determine whether a mobile device associated with a serving cell is to be handed over to the target cell in the cellular network. The network entity comprises: (i) a transceiver for wirelessly communicating with the mobile device and for providing RF coverage to the mobile device in the serving cell; (ii) a memory for storing program instructions; and (iii) a processor coupled to the memory and the transceiver and configured to execute the program instructions. The program instructions, when executed by the processor, cause the network entity to perform the following: (i) determine that the target cell is not defined as a neighbor of the serving cell in an NRT of the serving cell; (ii) in response to the determination that the target cell is not defined in the NRT of the source cell, query a SON server to provide information about a distance between the serving cell and the target cell and a tier value indicating a number of layers of cell sites between the serving cell and the target cell; (iii) receive the distance and the tier value information from the SON server; (iv) further determine that the distance is greater than a first threshold and the tier value is greater than a second threshold; and (v) classify the target cell as a boomer cell for the serving cell to prevent the handover of the mobile device to the target cell.

In a further embodiment, the present disclosure is directed to a non-transitory, computer-readable medium containing program instructions, which, when executed by a computer system, cause the computer system to perform the operations comprising: (i) calculating a distance between a source cell and a target cell in a cellular network and a tier value indicating a number of layers of cell sites between the source cell and the target cell in the cellular network, wherein the target cell is defined as having a neighbor relation with the source cell; (ii) determining that the distance is greater than a first threshold and the tier value is greater than a second threshold; (iii) creating a distribution of Timing Alignment (TA) samples for the target cell; (iv) further determining a proportion of Transport Block Size (TBS) that are power-restricted for the target cell; (v) ascertaining that a percentage of the TA samples having corresponding TA values greater than the first threshold exceeds a third threshold and that the proportion of power-restricted TBS exceeds a fourth threshold; and (vi) classifying the target cell as a boomer cell in response to the ascertaining, thereby preventing a handoff of a UE associated with the source cell to the target cell.

In still another embodiment, the present disclosure is directed to a computer system, which comprises: (i) a memory for storing program instructions; and (ii) a processor coupled to the memory and configured to execute the program instructions. The program instructions, when executed by the processor, cause the computer system to perform the following: (i) calculate a distance between a source cell and a target cell in a cellular network and a tier value indicating a number of layers of cell sites between the source cell and the target cell in the cellular network, wherein the target cell is defined as having a neighbor relation with the source cell; (ii) determine that the distance is greater than a first threshold and the tier value is greater than a second threshold; (iii) create a distribution of TA samples for the target cell; (iv) further determine a proportion of TBS that are power-restricted for the target cell; (v) ascertain that a percentage of the TA samples having corresponding TA values greater than the first threshold exceeds a third threshold and that the proportion of power-restricted TBS exceeds a fourth threshold; and (vi) classify the target cell as a boomer cell in response to the ascertaining, thereby preventing a handoff of a UE associated with the source cell to the target cell.

In a further embodiment, the present disclosure is directed to a wireless system comprising an eNB; and a computer system that is in communication with the eNB. In the wireless system, the eNB is configured to perform the following: (i) provide RF coverage over a serving cell associated with the eNB; (ii) further provide RF coverage to a UE associated with the serving cell in the wireless system; (iii) determine that a target cell reported by the UE is not defined as a neighbor of the serving cell in an NRT of the serving cell; (iv) in response to the determination that the target cell is not defined in the NRT of the serving cell, send a query to the computer system to request information about a distance between the serving cell and the target cell and a tier value indicating a number of layers of cell sites between the serving cell and the target cell; (v) receive the distance and the tier value information from the computer system; (vi) further determine that the distance is greater than a first threshold and the tier value is greater than a second threshold; and (vii) classify the target cell as a boomer cell for the serving cell to prevent the handover of the UE to the target cell. In the wireless system, the computer system is configured to perform the following: (i) receive the query from the eNB; (ii) calculate the distance and the tier value; and (iii) send the distance and the tier value to the eNB.

By automatically detecting boomer cells, particular embodiments of the present disclosure provide for an improved ANR procedure that can reject such boomer cells from being added to the neighbor list of a source cell. Furthermore, if existing neighbor cells are found to be boomer cells, they can be automatically removed from the neighbor list as well. Once a neighbor cell is identified as a boomer cell, all handovers to that boomer cell can be prevented to improve interference management and resource utilization in the network.

### BRIEF DESCRIPTION OF THE DRAWINGS

In the following section, the invention will be described with reference to exemplary embodiments illustrated in the figures, in which:

FIG. 1 illustrates an existing operational sequence as part of an Automatic Neighbor Relation (ANR) procedure in LTE to build a neighbor list (or NRT) at a serving cell in a wireless system for facilitating a future handover;

FIG. 2 shows a flowchart that provides details of each operation or step in the operational sequence illustrated in FIG. 1;

FIG. 3 is an exemplary illustration depicting the concept of a “boomer cell”;

FIG. 4A is an exemplary flowchart depicting steps that may be performed by an eNB of a serving cell to classify a newly-reported neighbor (target) cell as a boomer cell according to one embodiment of the present disclosure;

FIG. 4B shows an exemplary flowchart depicting steps that may be performed by a Self Organizing Network-Optimization Manager (SON-OM) server to classify an already-defined neighbor (target) cell as a boomer cell according to one embodiment of the present disclosure;

FIG. 5 is a diagram of an exemplary wireless system in which the boomer cell classification methodologies shown in FIGS. 4A-4B according to the teachings of particular embodiments of the present disclosure may be implemented;

FIG. 6 is an exemplary illustration of how a tier value for a target cell may be determined according to one embodiment of the present disclosure;

FIG. 7 is an exemplary flowchart illustrating how a source eNB may classify a target cell as a boomer cell according to particular embodiments of the present disclosure;

FIG. 8 shows an exemplary flowchart depicting how a SON-OM server may classify a currently-defined neighbor relation as a boomer relation according to particular embodiments of the present disclosure;

FIG. 9 is a block diagram of an exemplary SON application server according to one embodiment of the present disclosure; and

FIG. 10 depicts an exemplary block diagram of a base station that may function as a network entity according to one embodiment of the present disclosure.

### DETAILED DESCRIPTION

In the following detailed description, numerous specific details are set forth in order to provide a thorough understanding of the disclosure. However, it will be understood by those skilled in the art that the disclosed invention may be practiced without these specific details. In other instances, well-known methods, procedures, components and circuits have not been described in detail so as not to obscure the present disclosure. Additionally, it should be understood that although the disclosure is described primarily in the context of a cellular telephone/data network, the described invention can be implemented in all wireless networks (cellular or non-cellular) that utilize handovers or neighbor relation management using ANR-type functionality. Thus, the use of the term “cell”—as in the “serving cell,” “source cell,” “neighbor cell,” or the “target cell”—in the discussion below should not be construed to be limited to a cellular structure only.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “pre-defined,” “cell-related,” etc.) may be occasionally interchangeably used with its non-hyphenated version (e.g., “predefined,” “cell related,” etc.), and a capitalized entry (e.g., “Uplink,” “Downlink”) may be interchangeably used with its non-capitalized version (e.g., “uplink,” “downlink”). Such occasional interchangeable uses shall not be considered inconsistent with each other.

It is noted at the outset that the terms “coupled,” “connected”, “connecting,” “electrically connected,” etc., may be used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale.

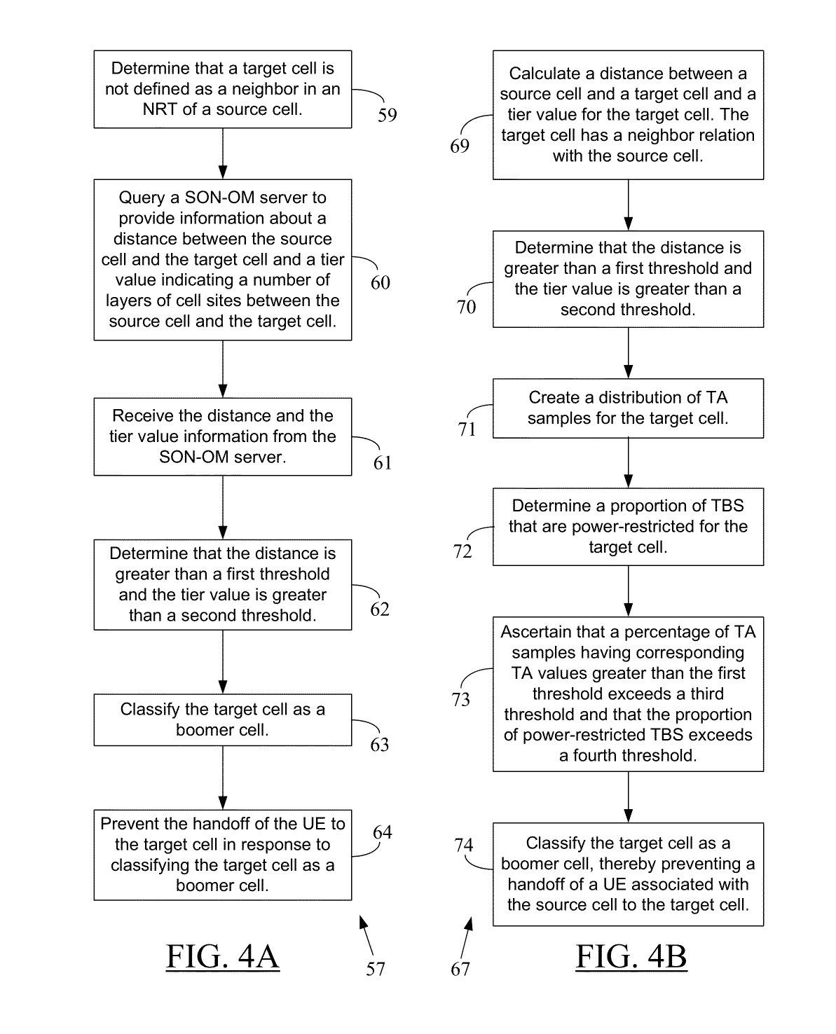

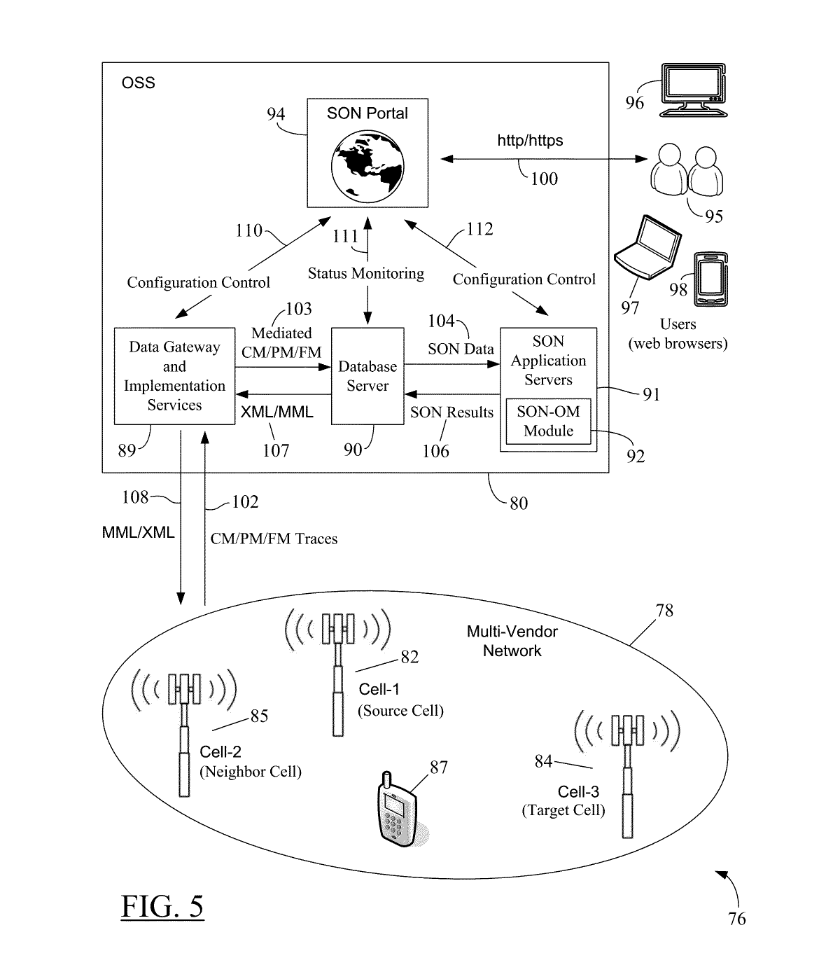

FIG. 4A is an exemplary flowchart 57 depicting steps 59-64 that may be performed by an eNB of a serving cell to classify a newly-reported neighbor (target) cell as a boomer cell according to one embodiment of the present disclosure. The target cell may be reported to the serving cell as a new neighbor by a UE attached to the serving cell. An exemplary system where the methodology in FIG. 4A may be implemented is shown in FIG. 5 discussed later below. As noted at block 59 in FIG. 4A, the source cell's eNB may initially determine that the newly-reported target cell is not defined as a neighbor of the source cell in a neighbor list or Neighbor Relations Table (NRT) of the serving cell. It is noted here that the terms “source cell” and “serving cell” are used interchangeably herein, so are the terms “neighbor list” and “NRT.” Furthermore, an eNB providing radio coverage over a source cell or “controlling” the source cell may be referred to as a “source eNB” or “serving eNB.” Similarly, there may be a “target eNB” associated with the target cell.

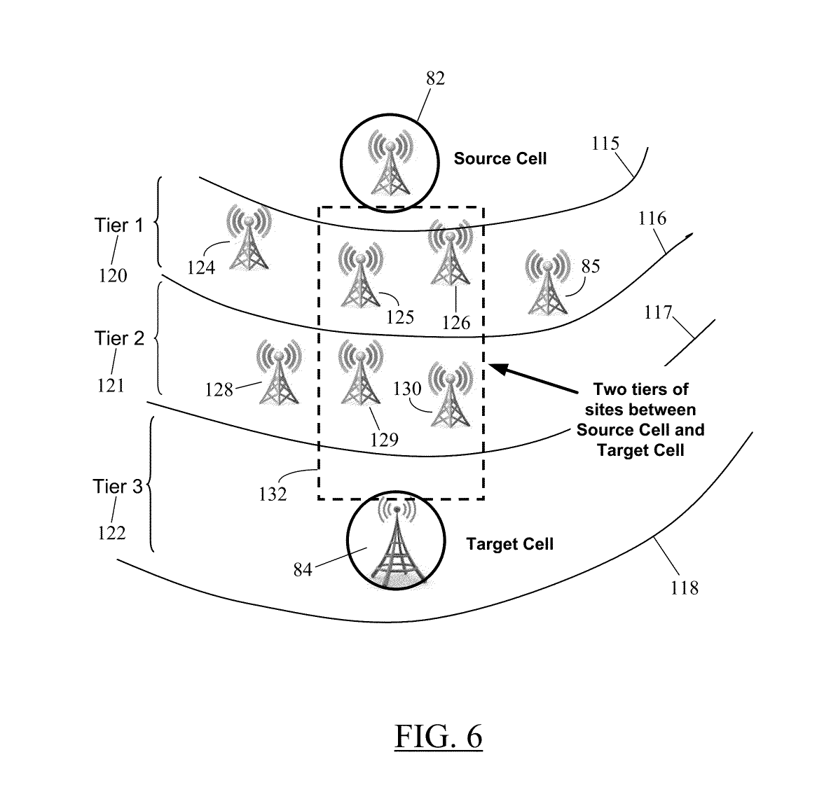

In response to the determination that the target cell is not defined in the source cell's NRT, in one embodiment, the source eNB may query a Self Organizing Network-Optimization Manager (SON-OM) server in the operator's network to provide information about the physical distance between the source cell and the target cell and a tier value indicating a number of layers of cell sites between the source cell and the target cell (block 60 in FIG. 4A). In one embodiment, the distance between the source cell and the target cell may refer to the physical distance between a cell tower or antenna(s) for the source cell and a cell tower or antenna(s) for the target cell. The tier value determination is illustrated in FIG. 6, which is discussed later below. In response to the query, at block 61, the source eNB may receive the requested distance and tier value information from the SON-OM server. Thereafter, at block 62, the source eNB may compare the distance and tier value against corresponding pre-defined thresholds and determine that the distance is greater than a first threshold and the tier value is greater than a second threshold. As a result of the determination at block 62, the serving eNB may classify the target cell as a boomer cell according to one embodiment of the present disclosure (block 63). When the new target cell is classified as a boomer cell, the source eNB may use ANR to create a neighbor relation to the target cell indicating the target cell as a boomer cell. As a result, the source eNB may prevent the handoff of a UE from the source cell to the target cell (block 64).

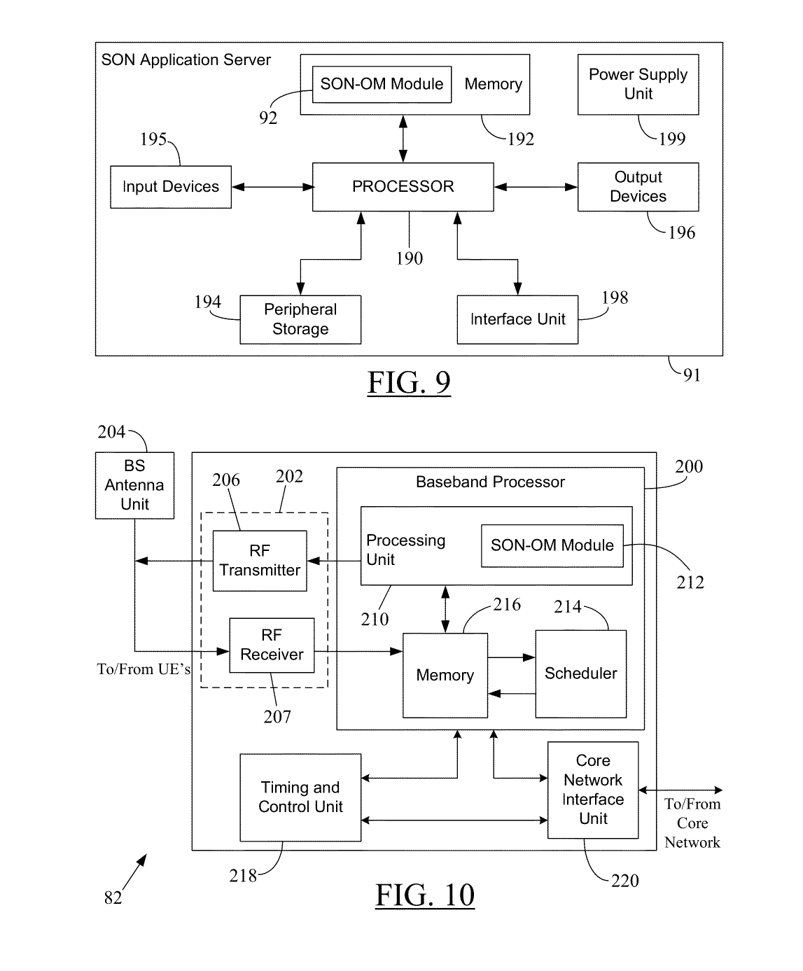

FIG. 4B shows an exemplary flowchart 67 depicting steps 69-74 that may be performed by a SON-OM server to classify an already-defined neighbor (target) cell as a boomer cell according to one embodiment of the present disclosure. An exemplary system where the methodology in FIG. 4B may be implemented is shown in FIG. 5 discussed later below. The SON-OM server may be a SON Application Server (AS) as shown in FIGS. 5 and 9, which are discussed later below. Alternatively, the SON-OM server may be any other entity configured to perform operations defined by a SON-OM module such as, for example, the SON-OM module 92 in FIG. 5 according to one embodiment of the present disclosure. The embodiment in FIG. 4A addresses a situation where a decision is to be made—e.g., by an eNB or by an ANR function in the eNB—to add or reject a new neighbor cell in a source cell's neighbor list depending on whether it is determined that the new neighbor is a boomer cell or not. On the other hand, the embodiment in FIG. 4B addresses a situation where a decision is to be made—by the SON-OM server—whether a neighbor cell that is already defined in a source cell's NRT can be classified as a boomer cell so that it can be blacklisted in the source cell's NRT.

Referring now to FIG. 4B, initially, at block 69, the SON-OM server may calculate the distance between a source cell and a target cell and a tier value for the target cell indicating the number of layers of cell sites between the source and the target cells. As noted above, the target cell in the embodiment of FIG. 4B is defined as already having a neighbor relation with the source cell. As also noted above, the distance between the source cell and the target cell may refer to the physical distance between a cell tower or antenna(s) for the source cell and a cell tower or antenna(s) for the target cell. The tier value determination is illustrated in FIG. 6, which is discussed later below. After calculation of the distance and the tier value, the SON-OM server may compare the distance and tier value against corresponding pre-defined thresholds and determine that the distance is greater than a first threshold and the tier value is greater than a second threshold (block 70). As a result of the determination at block 70, the SON-OM server may create a distribution of Timing Alignment (TA) samples for the target cell at block 71. The SON-OM server may also determine a proportion of Transport Block Size (TBS) that are power-restricted for the target cell (block 72). After the actions at blocks 71-72, the SON-OM server may ascertain, at block 73, that the percentage of TA samples having corresponding TA values greater than the first threshold (used at the determination at block 70) exceeds a third threshold, and that the proportion of power-restricted TBS exceeds a fourth threshold. In response to the ascertaining at block 73, the SON-OM server may classify the target cell as a boomer cell, thereby preventing an HO of a UE associated with the source cell to the target cell (block 74).

Additional details of the methodologies broadly outlined in the flowcharts 57, 67 in FIGS. 4A-4B, respectively, are now provided hereinbelow with reference to FIGS. 5-8.

Prior to continuing the discussion, it is observed here that whenever actions are described as being performed by a cell (e.g., source cell, target cell, etc.), such actions are actually performed by an eNB or other base station associated with that cell. In other words, in the discussion herein, a cell's and its eNB's actions/properties may be interchangeably described for the sake of convenience only; in practice, it is the eNB (providing RF coverage and other radio signal processing for the cell) that performs the described actions or possesses the described properties.

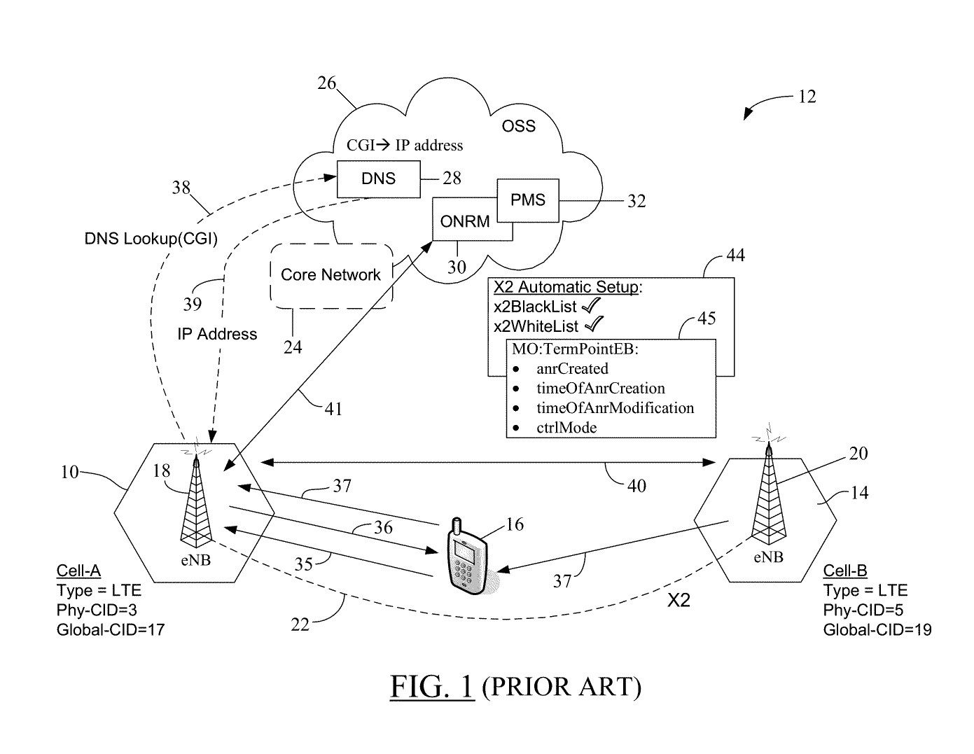

FIG. 5 is a diagram of an exemplary wireless system 76 in which the boomer cell classification methodologies shown in FIGS. 4A-4B according to the teachings of particular embodiments of the present disclosure may be implemented. The system 76 may include an operator network (or wireless network) 78 and an Operations Support System (OSS) 80, both in communication with each other. The operator network 78 may include a plurality of cells or cell sites—three of which are shown, through their representative base stations, by way of an example in FIG. 5 and identified by reference numerals 82, 84, and 85. It is noted that, for ease of illustration and discussion, only the base stations 82, 84, and 85 are shown in FIG. 5 without corresponding cell sites or cells (like the cells 10 and 14 shown in FIG. 1) and the same reference numeral is used hereinbelow to refer to a cell as well as its BS or eNB. In the embodiment of FIG. 5, a single mobile handset 87 is shown by way of an example and ease of illustration. However, it is understood that there may be many such mobile handsets operational in the network 78. In one embodiment, the wireless network 78 may be a multi-vendor network in the sense that the base stations 82, 84, and 85 in the network 78 may be supplied by or operated by different vendors. Although not shown in FIG. 5, the wireless system 76 may also include a Core Network (CN) (like the CN 24 in FIG. 1) through which eNBs 82 and 84-85 may communicate with the OSS 80. Because of its lack of relevance to the discussion below, a CN, which may be an EPC in LTE, and its component nodes are not shown in FIG. 5. The OSS 80 may be a modified version of the OSS 26 shown in FIG. 1; the modification enabling the OSS 80 to support the methodologies shown in FIGS. 4A-4B and FIGS. 7-8. As noted before in the context of the OSS 26 in FIG. 1, the OSS 80 also may be an OSS-RC. Although not shown explicitly, it is noted here that each eNB 82, 84, 85 may be connected to the OSS 80 either directly or through a CN (not shown). Like the OSS 26 in FIG. 1, the OSS 80 in FIG. 5 also may provide a proprietary (network operator-specific) platform for supervision, configuration, deployment and optimization of a mobile or cellular network (e.g., the wireless network 78), with features tailored to promote efficient working procedures in daily network operations. The OSS 80 also may provide full support for management of fault, performance, and network configuration, and may also provide a number of new applications that may be used in the trouble-shooting and network optimization stages.

In the embodiment of FIG. 5, Cell-1 (identified by reference numeral “82”) is treated as a “source cell” or “serving cell”, whereas Cell-2 (identified by reference numeral “85”) is considered as a neighbor cell to Cell-1 and Cell-3 (identified by reference numeral “85”) is treated as a “target cell” to which the mobile handset or UE 87 is supposed to be handed off by the source cell 82. The UE 87 is assumed to be attached to the source cell 82—i.e., the eNB 82 may be considered to be in “control” of the UE 87 and providing RF coverage to the UE 87 prior to its handover. It is noted that any of the other base stations 84-85 may also perform as “source cells” for their respective UEs (not shown).

In one embodiment, one or more of the base stations 82, 84-85 may be base stations in a Third Generation (3G) network, or eNBs when the operator network 78 is an LTE network, or home base stations or femtocells, and may provide radio interface to respective mobile handsets attached thereto. In other embodiments, the base station may also include a site controller, an access point (AP), a radio tower, or any other type of radio interface device capable of operating in a wireless environment. It is noted here that the terms “mobile handset,” “wireless handset,” “wireless device,” “terminal,” and “User Equipment (UE)” may be used interchangeably herein to refer to a wireless communication device that is capable of voice and/or data communication via a wireless carrier network and also capable of being mobile. Some examples of such mobile handsets/devices include cellular telephones or data transfer equipments (e.g., a Personal Digital Assistant (PDA) or a pager), smartphones (e.g., iPhone™, Android™, Blackberry™, etc.), computers, Bluetooth® devices, or any other type of user devices capable of operating in a wireless environment. Similarly, the terms “wireless network,” “carrier network,” or “operator network” may be used interchangeably herein to refer to a wireless communication network (e.g., a cellular network) facilitating voice and/or data communication between two user equipments (UEs).

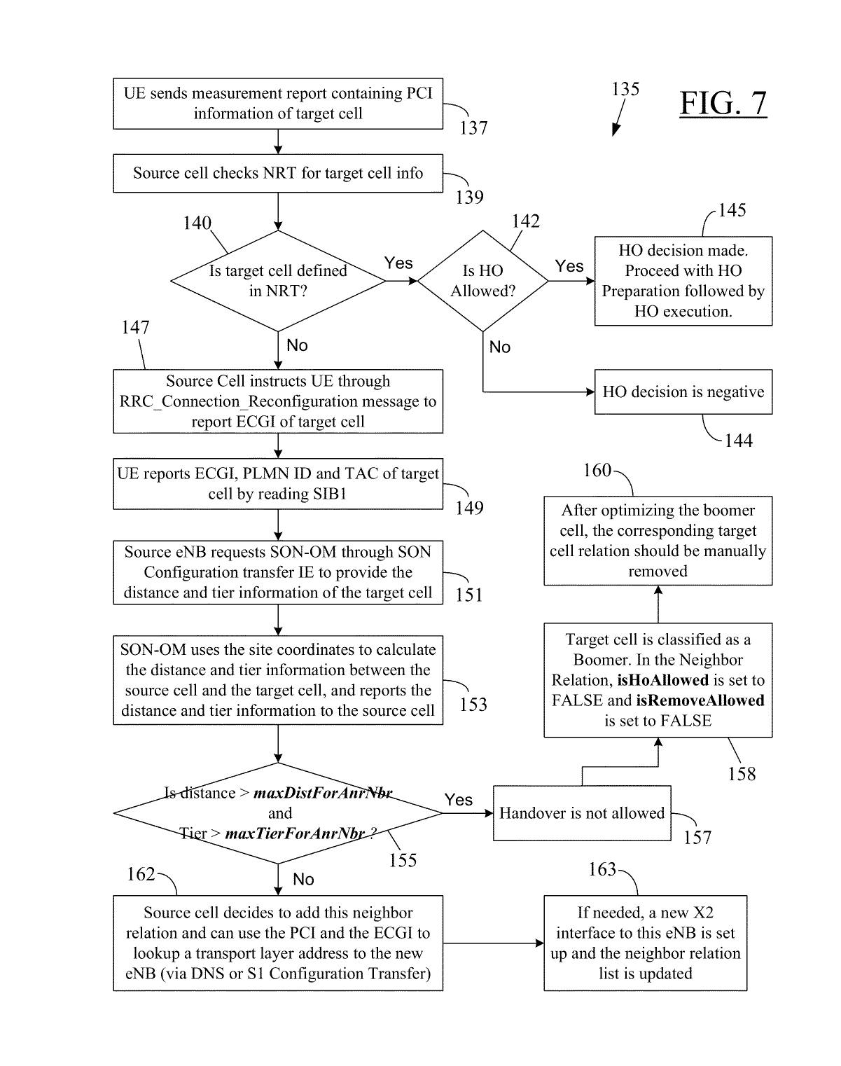

In the wireless network 78 of FIG. 5, the BS or eNodeB 82 may be configured to implement the eNB-related steps outlined in the flowcharts in FIGS. 4A and 7 (which is discussed later below). It is understood that any of the other base stations 84-85 may be similarly configured as well. In addition to providing air interface or communication channel to the UE 87, the BS 82 may also perform radio resource management (as, for example, in case of an eNodeB in an LTE system) using, for example, channel feedbacks received from the UE 87. The communication channel (e.g., a Radio Frequency (RF) channel) (not shown) between the base station 82 and the UE 87 may provide a conduit for the signals exchanged between the base station 82 and UE 87.

It is noted here that when the wireless network 78 is a cellular network, the eNB 82 may be associated with a particular cell (the “source cell” here) and may provide RF coverage to the UE 87 as its serving eNB. The UE 87 may be served by the eNB 82 because it may be physically present, registered, associated with (e.g., through RF coverage or prior handover), or operating within the eNB's source cell 82. In the discussion herein, the eNB 82 is considered as the “serving” or “source” eNB (like the eNB 18 in FIG. 1, but having additional functionality according to the teachings of the present disclosure). A corresponding target eNB (like the eNB 20 in FIG. 1) is assumed to be the eNB 84.

Although various examples in the discussion below are provided primarily in the context of an LTE network, the teachings of the present disclosure may equally apply, with suitable modifications (as may be apparent to one skilled in the art using the present teachings), to a number of different Frequency Division Multiplex (FDM) or Time Division Multiplex (TDM) based wireless systems or networks that may support handovers of mobile handsets through management of neighbor relations using ANR or similar functionality. Such networks or systems may include, for example, standard-based systems/networks using Second Generation (2G), Third Generation (3G), or Fourth Generation (4G) specifications, or non-standard based systems. Some examples of such systems or networks include, but not limited to, Global System for Mobile communications (GSM) networks, Telecommunications Industry Association/Electronic Industries Alliance (TIA/EIA) Interim Standard-136 (IS-136) based Time Division Multiple Access (TDMA) systems, Wideband Code Division Multiple Access (WCDMA) systems, 3GPP LTE networks, WCDMA-based High Speed Packet Access (HSPA) systems, 3GPP2's CDMA based High Rate Packet Data (HRPD) systems, CDMA2000 or TIA/EIA IS-2000 systems, Evolution-Data Optimized (EV-DO) systems, Worldwide Interoperability for Microwave Access (WiMAX) systems based on Institute of Electrical and Electronics Engineers (IEEE) standard IEEE 802.16e, International Mobile Telecommunications-Advanced (IMT-Advanced) systems (e.g., LTE Advanced systems), other Universal Terrestrial Radio Access Networks (UTRAN) or Evolved-UTRAN (E-UTRAN) networks, GSM/Enhanced Data Rate for GSM Evolution (GSM/EDGE) systems, a non-standard based proprietary corporate wireless network, etc.

Each base station (BS) 82, 84, 85 in FIG. 5 may be referred to as a “network entity,” “access node” or “mobile communication node.” In case of a 3G carrier network 78, the base stations 82 and 84-85 may include functionalities of a 3G base station (or RBS) along with some or all functionalities of a 3G Radio Network Controller (RNC), and any or all of the BSs 84-85 may be configured to perform boomer cell classification as discussed hereinbelow with reference to BS 82 as an example. Communication nodes in other types of carrier networks (e.g., 2G networks, or 4G networks and beyond) also may be configured similarly. In the embodiment of FIG. 5, the node 82 may be configured (in hardware, via software, or both) to implement the boomer cell classification approach as per teachings of the present disclosure. For example, when existing hardware architecture of the access node 82 cannot be modified, the boomer cell classification methodology according to one embodiment of the present disclosure may be implemented through suitable programming of one or more processors (e.g., the processor 200 (or, more particularly, the processing unit 210) in FIG. 10) in the access node 82 or a Base Station Controller (BSC) (if available). The execution of the program code (by a processor in the node 82) may cause the processor to perform the eNB-related steps outlined in FIGS. 4A and 7 (discussed later). In one embodiment, the eNB 82 may include a SON-OM module (as shown by way of example in FIG. 10 and discussed later hereinbelow). This module (preferably implemented in software) may be configured according to the teachings of the present disclosure to support the boomer cell classification approach discussed later below. Thus, in the discussion below, although the communication node 82 (or its BSC)—may be referred to as “performing,” “accomplishing,” or “carrying out” a function or process, it is evident to one skilled in the art that such performance may be technically accomplished in hardware and/or software as desired.

As mentioned earlier, the wireless system 76 may include a Core Network (CN) (not shown) coupled to the communication nodes 82, 84-85 and providing logical and control functions (e.g., subscriber account management, billing, subscriber mobility management, etc.) for the network 78. In case of an LTE carrier network, the core network may be an Access Gateway (AGW) or may function in conjunction with a subnet-specific gateway/control node (not shown in FIG. 5). Regardless of the type of the carrier network 78, the core network may function to provide connection of one or more of the UEs (like the UE 87) to other mobile handsets operating in the carrier network 78 and also to other communication devices (e.g., wireline or wireless phones) or resources (e.g., an Internet website) in other voice and/or data networks external to the carrier network 78. In that regard, the core network may be coupled to a packet-switched network (e.g., an Internet Protocol (IP) network such as the Internet) (not shown) as well as a circuit-switched network such as the Public-Switched Telephone Network (PSTN) (not shown) to accomplish the desired connections beyond the devices operating in the carrier network 78. Thus, through the communication node's 82 connection to the core network and a handset's radio link with the communication node 82, a user of the handset (e.g., UE 87) may wirelessly (and seamlessly) access many different resources or systems beyond those operating within the operator's network 78.

As is understood, the operator network 78 may be a cellular telephone network or a Public Land Mobile Network (PLMN) in which the UE 87 and similar other UEs or mobile handsets (not shown) may be subscriber units. However, as mentioned before, the present invention is operable in other non-cellular wireless networks as well (whether voice networks, data networks, or both). Furthermore, portions of the operator network 78 or the wireless system 76 may include, independently or in combination, any of the present or future wireline or wireless communication networks such as, for example, the PSTN, an IP Multimedia Subsystem (IMS) based network, or a satellite-based communication link. Similarly, as also mentioned above, the operator network 78 may be connected to the Internet via its respective core network's connection to an IP (packet-switched) network or may include a portion of the Internet as part thereof. In one embodiment, the operator network 78 or the wireless system 76 may include more or less or different type of functional entities than those shown in the context of FIG. 5.

In the discussion below, various actions, as shown, for example, in FIGS. 4A and 7 according to the teachings of particular embodiments of the present disclosure, may be described as being performed by a “network entity” such as the source eNB 82 in FIG. 5. Although the discussion herein primarily refers to a base station or an eNB as such a “network entity,” it is understood that in certain embodiments the term “network entity” may refer to a macro base station operating in conjunction with a secondary entity such as a pico or femto base station, a secondary entity such as a pico or femto base station, a group of base stations, an RNC, a Base Transceiver Station (BTS) (with or without the functionalities of a BSC), a core network, an OSS-based entity, a BSC, or a combination of one or more base stations (with or without the functionalities of a BSC or an RNC) and a CN. For example, in an LTE network, an eNB may be configured to perform the functions of a “network entity” discussed herein. Similarly, when certain RNC functionalities are implemented in a CN, the CN may represent the “network entity” described herein. If the RNC functionality according to particular embodiments of the present disclosure is distributed between a BS and a CN, then the “network entity” may be a combination of such a BS and CN. On the other hand, in particular embodiments, a combination of multiple base stations or a single BS and some other node(s) (not shown) may constitute the “network entity” discussed herein. Another entity (which may be IP-based) in the network 78 or in the wireless system 76 other than those mentioned above may be configured to perform as a “network entity” as per the teachings of the present disclosure. Furthermore, in the discussion below, although the network entity may be referred to as “performing,” “accomplishing,” or “carrying out” a function or process, such performance may be technically accomplished in hardware and/or software as desired.

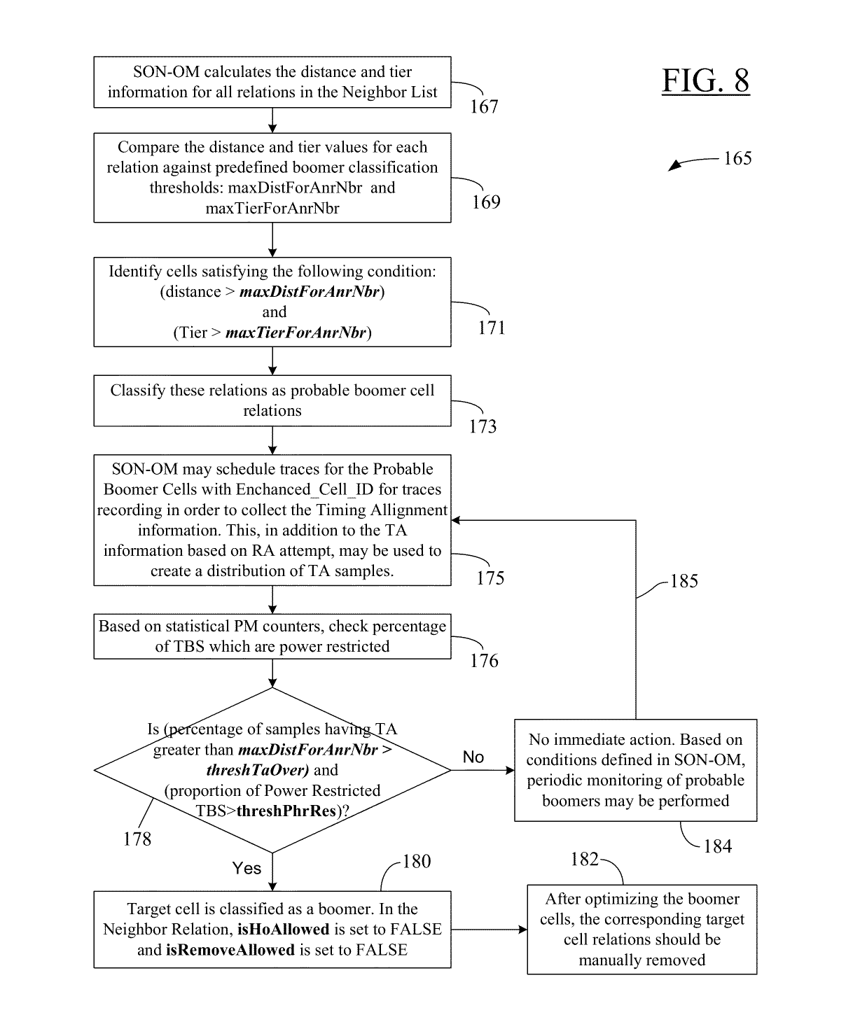

Referring again to FIG. 5, the OSS 80 also may include a DNS module (like the DNS module 28 in FIG. 1), an ONRM module (like the ONRM module 30 in FIG. 1), and a PMS module (like the PMS module 32 in FIG. 1), like the OSS 26 in FIG. 1. However, for ease of illustration, these modules are not shown in the OSS 80 in FIG. 5. On the other hand, modules or components relevant to the discussion below are shown as part of the OSS 80 in FIG. 5. Thus, the OSS 80 is shown to include a data gateway module 89, a database server 90, and a SON Application Server (AS) 91. In one embodiment, the SON AS 91 may include a SON Optimization Manager (SON-OM) module 92, which, in one embodiment, may be a software module. The program code for the SON-OM module 92, upon execution, may configure the SON AS 91 (also referred to herein as a “SON-OM server”) to perform the operations depicted in FIGS. 4B and 8 (discussed below). Some exemplary architectural details for the SON AS 91 are shown in FIG. 9 (discussed below). In the discussion below, although the terms “SON-OM,” “SON-OM server,” and SON-OM module” are used interchangeably primarily to refer to the SON AS 91, in certain embodiments, these terms may also refer to any other sever, computer, or data processing unit configured by the SON-OM module 92 to carry out the boomer cell classification methodology according to particular embodiments of the present disclosure. Also, for ease of discussion, the SON AS 91 may be treated as the same as the SON-OM 92 in particular embodiments of the present disclosure so far as the functionalities relevant to the present disclosure are concerned.

The OSS 80 may also host a SON portal 94 through which one or more users 95 may access, manage, configure, and/or control the functionalities of the OSS modules 89-91. In one embodiment, the SON portal 94 may be an Internet-based web portal that can be accessed with user devices 96-98 via Hypertext Transfer Protocol (HTTP) or Hypertext Transfer Protocol Secure (HTTPS) based communication links as indicated by arrow 100 in FIG. 5. The user devices 96-98 may include web browsers supporting such communication with the SON portal 94. The user devices 96-98 may be any type of computing device or wireless unit capable of data entry and browser-based communication. Such devices may include, for example, a desktop computer, a workstation, a laptop computer, a mobile handset, etc. The users 95 may be employees of the operator of the carrier network 78 assigned with the task of managing the SON configuration in the OSS 80. Alternatively, the users 95 may be any other service or administrative personnel being responsible to manage the SON configuration.

As is known, a Self Organizing Network (SON) is an automation technology designed to make the planning, configuration, management, optimization, and healing of mobile radio access networks (such as the operator network 78) simpler and faster. With radio networks like those used for LTE and other modern cellular technologies becoming more complex, SON has been introduced by 3GPP to make network planning easier by automating the previously-mentioned aspects of a mobile network's operation. With the networks themselves being able to monitor their own performance using SON features, they can optimize themselves to be able to provide the optimum performance. As a result, network operators can benefit from significant improvements in terms of both Capital Expenditure (CAPEX) and Operational Expenditure (OPEX). The SON functionality and behavior has been defined and specified by 3GPP starting with 3GPP Release 8 and subsequent 3GPP Technical Specifications (TS) such as, for example, 3GPP TS 32.501, version 12.1.0 (December 2013), titled “Telecommunication management; Self-Configuration of network elements; Concepts and requirements (Release 12)”; 3GPP TS 32.511, version 11.2.0 (September 2012), titled “Telecommunication Management; Automatic Neighbour Relation (ANR) management; Concepts and requirements (Release 11)”; 3GPP TS 32.521, version 11.1.0 (December 2012), titled “Telecommunication management; Self-Organizing Networks (SON) Policy Network Resource Model (NRM) Integration Reference Point (IRP); Requirements (Release 11)”; and 3GPP TS 32.541, version 11.0.0 (September 2012), titled “Telecommunication management; Self-Organizing Networks (SON); Self-healing concepts and requirements (Release 11).”

There may be at least two different types of SON configurations that may be used to implement the SON-OM module 92 configured as per teachings of the present disclosure to enable implementation of the functionalities illustrated in FIGS. 4B and 8. In a Distributed SON (D-SON), certain SON functions may be distributed among the network elements at the edge of the network, typically eNodeB elements. Such eNodeB configurations may be supplied by the network equipment vendor manufacturing or supplying the respective radio cell. On the other hand, in a Centralized SON (C-SON), functions are typically concentrated closer to higher-order network nodes or the network OSS. Due to the need to inter-work with cells supplied by different equipment vendors, C-SON systems are more typically supplied by non-vendor third parties. The embodiment in FIG. 5 may illustrate a C-SON configuration where the SON-OM module 92 resides as part of the network-wide, centralized OSS 80. However, in another embodiment, a D-SON configuration (not shown) may be employed, wherein a SON-OM module may be implemented as part of the source eNB 82 (or any other eNB functioning as a source eNB to carry out the operations illustrated in FIGS. 4A and 7). Alternatively, in a further embodiment, the functionality of the SON-OM module 92 may be divided between the SON AS 91 and the source eNB 82—each containing a relevant portion of the program code such that both of these portions, when combined, constitute the SON-OM module 92. The embodiment in FIG. 10 illustrates one such configuration for the source eNB 82. In another embodiment, the SON-OM module 92 may reside outside of the OSS 80 such as, for example, in a dedicated (or shared) server or computer (not shown) that is coupled to the OSS 80 (but is not part of the OSS 80). Such external server or computer may not have to be a SON AS. In one embodiment, the SON-OM module 92 may be rather part of a core network (not shown) for the carrier network 78.

Referring again to FIG. 5, as part of the SON functionality, the eNBs 82, 84, 85 in the carrier network 78 may report certain “traces” to the SON AS 91 (as symbolically indicated by arrow 102). Such “traces” may include “snapshots” of actual operational parameters related to Connection Management (CM), Fault Management (FM), and Performance Management (PM) of various elements in the network 78. An eNB may activate or deactivate a Trace Session (TS) (also referred to as Session Trace (ST)) for a subscriber, for example as a tool for network and service troubleshooting. Alternatively, the SON AS 91, or a user 95 (through the SON portal 94) may instruct an eNB to initiate a trace session as part of automated network management using SON functionality. An ST may provide near real-time information about a subscriber UE's 87 session (call session, data session, etc.) in the network 78 and the UE's 87 interaction with the network 78, and let the SON AS 91 automatically perform detailed analyses of signaling procedures observed as part of the trace sessions to fulfill the three primary objectives of SON functionality—self-configuration, self-optimization, and self-healing. A user 95 also may access and analyze these traces. In FIG. 5, the traces collected by an eNB may be sent to the data gateway and implementation services module 89, which may initially “format” the received data and send it for storage in a SON database server 90 as indicated at arrow 103. The SON AS 91 may retrieve the trace data from the database server 90 (as indicated by arrow 104), analyze the data as necessary, and provide the results back to the database server 90 as indicated by arrow 106. The database server 90 may send the SON results as Extensible Markup Language (XML) or Mail Meta Language (MML) content to the corresponding eNB or other network node in the carrier network 78 as indicated by arrows 107-108. Instead of XML or MML, other suitable markup language may be used as well to convey SON configuration information to the network elements in the operator's network 78. The XML or MML content may allow the SON AS 91 to ensure consistency throughout the network 78 as well as to make global changes, if needed, throughout various nodes in the network 78. Thus, the received MML/XML content or instructions maybe used by the relevant eNB(s) or other entities in the network 78 to carry out the SON-related planning, configuration, management, optimization, and/or healing in the carrier network 78. It is noted here that information or content other than the above-mentioned traces may be exchanged as well between a network entity in the carrier network 78 and the SON AS 91, with or without the involvement of a core network (not shown).

A user 95 may monitor and control various operational aspects of the SON entities 89-91 by communicating with them through the SON portal 94 via appropriate user device 96-98, as symbolically illustrated by arrows 110-112 in FIG. 5.

Prior to discussing FIG. 6, it is noted here that the ANR functionality in LTE may be considered a part of the SON features. The ANR functionality relieves an operator from the burden of manually managing Neighbor Relations (NRs) of each cell to successfully manage handovers in the operator's network. Because of automated management of neighbor relations using ANR, optimized and up-to-date neighbor lists may be efficiently maintained at each eNB in the network. Hence, the network performance (e.g., less dropped calls) is improved because of successful handovers based on the correct neighbor lists. In one embodiment, although an ANR function may reside in an eNB, it may interact with and be “managed” by an OSS-based entity such as, for example, the SON AS 91.

FIG. 6 is an exemplary illustration of how a tier value for a target cell may be determined according to one embodiment of the present disclosure. The term “tier”, as used herein, may refer to the number of “layers” of cell sites between a source cell such as, for example, the source cell 82 in FIG. 5, and a target cell such as, for example, the target cell 84 in FIG. 5. Each “layer” may comprise of cell sites which are approximately grouped to fall on the locus of a system-defined (albeit imaginary) circle or substantially circular boundary whose center is the source cell. Multiple such concentric circles or substantially circular boundaries 115-118 may be defined, for example, by a SON-OM server according to one embodiment of the present disclosure as a computational tool to create different “tiers” 120-122 of cell sites located between the source cell 82 and the target cell 84. The “tiers” may be defined in such a manner as to accommodate those neighbors of a source cell 82 that are located between the source and the target cells at different physical distances from the source cell 82. Some exemplary neighbor cells are shown in FIG. 6 for illustration purpose only. Thus, as shown in FIG. 6, Tier-1 for the source cell 82 may include neighbor cells 85 (from FIG. 5) and 124-126 and Tier-2 may include additional neighbors 128-130. In the illustration of FIG. 6, the target cell 84 may be considered to have a tier value of “3” (three) because the target cell 84 is located in the third tier 122. In other words, in FIG. 6, there are two tiers of cell sites between the source cell and the target cell as indicated by the dotted box 132.

The radius of each, substantially circular boundary 115-118 may be defined with a progressively increasing value taking into account such factors as whether the cell sites are in an urban versus a rural area, how closely-spaced the cell sites are, the strengths of the signals received from a cell, the level of interference experienced by a UE attached to the source cell 82, the number of potential neighboring cells available for handover, etc. Hence, a “tier value” may be flexibly-defined. For example, the tier value for the target cell 84 may be lower in a rural area where there may be less number of cells and those cells may be sparsely distributed, which may result in less layers of cell sites between the source cell 82 and the target cell 84. On the other hand, for the same physical distance between the source cell 82 and the target cell 84, in a congested urban environment, the target cell 84 may have a higher tier value because of more closely-spaced tiers 120-122.

FIG. 7 is an exemplary flowchart 135 illustrating how a source eNB such as, for example, the eNB 82 in FIG. 5, may classify a target cell such as, for example, the target cell 84 in FIG. 5, as a boomer cell according to particular embodiments of the present disclosure. As noted before with reference to FIG. 5, Cell-1 is assumed to be the serving cell, Cell-2 is assumed to be a neighbor cell to Cell-1, and Cell-3 is treated as the target cell to which the UE 87 is supposed to be handed off by Cell-1. Initially, at block 137, Cell-1 may receive a measurement report from the UE 87 (i.e., the UE 87 may send this measurement report to its service Cell-1). The measurement report may contain the PCI information of Cell-3. As is understood, in an LTE network, the handover procedure starts with the measurement reporting of a handover event by a UE to its serving eNB. The UE 87 periodically performs DL radio channel measurements based on the Reference Symbols (RS); namely, the UE can measure the RSRP and the RSRQ from its serving cell 82 as well as from the strongest adjacent cells 84-85 in the system. If certain network-configured conditions are satisfied, the UE 87 sends the corresponding measurement report (to its serving cell) indicating the triggered event. For example, when the handover (HO) algorithm is based on RSRP values, HO is triggered when the RSRP value from an adjacent cell is higher than the one from the serving cell by a network-specified number of decibels (dBs). In other words, as soon as the strength of the serving cell's RF signals falls below a certain threshold, the UE 87 may automatically search for a neighboring cell in anticipation of good RF signals. As soon as RF signals from a neighbor cell (here, the “target cell” or “detected cell” 84) becomes better than a certain threshold, the UE 87 may send the neighbor cell's RF information to its serving cell (i.e., serving eNB 82) in a report called “Measurement Report.” In addition, the measurement report indicates the cell (referred to as the “target cell”) to which the UE has to be handed over. The measurement reports at block 137 in FIG. 7 also indicate such information to the serving cell, so that the serving eNB 82 becomes aware of the “detected” neighbor cell 84. In LTE, for example, the triggers and thresholds for various “events” may be provided to a UE in the form of System Information (SI) and the UE may then constantly check for the triggers.

Based on the measurement reports, the serving eNB (in UE's source cell) may start HO preparation. Thus, at blocks 139-140, the source eNB 82 may check its NRT to determine if the target cell 84 is already defined in the NRT as a neighbor of the source cell 82. If Cell-3 is defined in the NRT of Cell-1, then the source eNB 82 may perform a check on its NRT to verify if a handoff is allowed to Cell-3 (blocks 140 and 142 in FIG. 7). If an HO is not allowed, then the source eNB 82 will disallow UE's 87 handoff request (block 144). On the other hand, if an HO is allowed as per the NRT, then the source eNB 82 may select Cell-3 as a neighbor for handoff and also instruct the UE 87, through the Radio Resource Control (RRC) Connection Reconfiguration message, to perform the HO to Cell-3 (block 145). The RRC Connection Reconfiguration message is defined, for example, in section 5.3.5 of the 3GPP TS 36.331, version 9.5.0 (December 2010), titled “Evolved Universal Terrestrial Radio Access (E-UTRA); Radio Resource Control (RRC); Protocol specification (Release 9).” As noted at block 145, the source eNB 82 may also perform HO preparation followed by HO execution. The HO preparation may include exchanging of signaling between serving and target eNBs and admission control of the UE in the target cell. The “X2” communication interface between the serving and target eNBs may be used to carry out necessary HO-related signaling. Upon successful HO preparation, the HO decision is made (by the source eNB) and, consequently, the HO Command will be sent to the UE (from the source eNB). The UE may then attempt to synchronize and access the target eNB to effectuate the handover.

Referring again to FIG. 7, if the source eNB 82 determines at decision block 140 that Cell-3 is not defined as a neighbor of Cell-1 in Cell-1's NRT, then, in one embodiment, the source eNB 82 may instruct the UE 87, through the RRC Connection Reconfiguration message, to send the ECGI of Cell-3 to the source eNB 82 (block 147). In response, the UE 87 may read the System Information Block 1 (SIB1) of Cell-3 (as broadcast by the target eNB 84) to obtain the ECGI, PLMN ID and TAC of the target cell 84. The UE 87 may then report the ECGI, PLMN ID and TAC of Cell-3 to the source eNB 82 (block 149). In one embodiment, based on the PCI and ECGI reported for Cell-3, the ANR function within the source eNB 82 may use the SON Configuration Transfer Information Element (IE) to query the SON-OM server (such as, for example, the SON AS 91 executing the SON-OM module 92 in FIG. 5) to provide the distance and tier information of the target cell 84 (block 151). The SON Configuration Transfer IE is defined, for example, in section 9.2.3.26 of the 3GPP TS 36.413, version 12.1.0 (March 2014), titled “Evolved Universal Terrestrial Radio Access Network (E-UTRAN); S1 Application Protocol (S1AP) (Release 12).” As indicated at block 153 in FIG. 7, the SON-OM server may use the site coordinates of the source and the target cells to calculate the distance between the source and the target cells and the tier value for the target cell, and then report the distance and tier information to the source eNB 82. As part of the calculations at block 153, in one embodiment, the SON-OM server may use the latitude and longitude of the source eNB 82 and the target eNB 84 to compute (i) the physical distance between a cell tower or antenna(s) for the source cell and a cell tower or antenna(s) for the target cell, and (ii) the tier value for target cell 84 using the approach outlined in FIG. 6 discussed earlier.

In rural environments, distant cells may be valid target cells to effectuate a successful handover. Hence, if only distance is considered as a boomer classification parameter, then a distant cell may be wrongly classified as a “boomer cell” in a rural environment. This could result in unsuccessful or incomplete handovers. Hence, in particular embodiments of the present disclosure, the distance and tier information are used in conjunction to accurately specify a boomer neighbor instead of the distance information alone so that in rural environments, where inter-site distance is higher, cells may not be erroneously classified as boomer neighbors based on distance alone. Thus, as noted earlier with reference to FIG. 6, for the same physical distance between a source cell and a target cell, the target cell may have a lower tier value in a rural environment as opposed to in an urban setting.

At the decision block 155, the source eNB 82 may compare the distance and tier information received from the SON-OM server against a pair of pre-defined thresholds—the maxDistForAnrNbr threshold for distance and the maxTierForAnrNbr threshold for tier. The maxDistForAnrNbr threshold may define a maximum distance for a neighbor (target) cell to be considered a valid neighbor under ANR and the maxTierForAnrNbr threshold may define a maximum tier value allowable for a neighbor (target) cell to be considered a valid neighbor under ANR. For example, for the LTE 2100 MHz band, the maxDistForAnrNbr threshold may be 1200 meters in one embodiment. For the same LTE band, the maxDistForAnrNbr threshold may be 1500 meters in another embodiment. On the other hand, the maxTierForAnrNbr threshold may have a value of “3.” In one embodiment, the values for the maxDistForAnrNbr and the maxTierForAnrNbr parameters may be stored in a memory of the source eNB 82 (such as, for example, the memory 216 in FIG. 10) by a user 95 as part of configuring the source eNB 82. Alternatively, the OSS 80 or the SON-OM server (e.g., the SON AS 91) may be configured to define and provide these values to the source eNB 82.

If the decision is “yes” at block 155 (i.e., the distance and tier values are greater than the thresholds), then the target cell 84 may be marked as a “boomer cell” and, consequently, the source eNB 82 may not allow the UE's 87 handoff to the target cell 84 (block 157). The source eNB 82 may also create a Neighbor Relation (NR) in the source eNB's NRT indicating the target cell 84 as a boomer cell (block 158). The source eNB's 82 ANR function may report such boomer cell classification to its SON-based counterpart in the OSS—e.g., the ANR function supported by the SON-OM server. In one embodiment, the handoff by the source eNB 82 may be prevented by setting two OSS-controlled NR attributes (or flags) in the source eNB's NRT to the “FALSE” value. Thus, when the OSS 80 is notified by the source eNB 82 that the target cell 84 is identified as a boomer cell, in one embodiment, the OSS-based SON-OM server may set the isHoAllowed flag in the source eNB's NRT to the “FALSE” value, and the isRemoveAllowed flag in the source eNB's NRT to the “FALSE” value as well for the particular NR under consideration (block 158). In other words, the source eNB 82 may receive from the SON-OM server “FALSE” values for isHoAllowed and isRemoveAllowed parameters in the context of the source cell's recently-identified neighbor relation with the target cell 84. When isHoAllowed=FALSE, it will allow source eNB 82 to blacklist the target cell 84 in the source cell's NRT to prevent triggering of a handoff of the UE 87 to the target cell. The source eNB 82 may blacklist the target cell 84 in both the “RRC idle” mode as well as the “RRC connected” mode. Also, when isRemoveAllowed=FALSE, it will allow source eNB 82 to prevent removal of the target cell's blacklisted status from the source cell's NRT. As is known, the ANR function in the source eNB 82 may automatically remove a blacklisted relation if statistical information from the OSS 80 indicates no handovers to a blacklisted cell over a specified period of time. To prevent such automatic removal, the isRemoveAllowed attribute may be set to the “FALSE” value.

As per the earlier-mentioned 3GPP TS 32.511, an NR status may be “locked” or “unlocked,” whereas an HO status may be “allowed” or “prohibited.” The “locked” NR status indicates that the corresponding NR shall not be removed by the ANR function, whereas the “unlocked” NR status indicates that the related NR may be removed by the ANR function. Similarly, the “allowed” HO status indicates that handovers are allowed for the associated NR, whereas the “prohibited” HO status indicates that the handovers are prohibited for the associated NR. Thus, the combination of the “locked” NR status and the “allowed” HO status is considered a “whitelisted” relation, whereas the combination of the “locked” NR status and the “prohibited” HO status is a “blacklisted” relation. When the target cell 84 is a boomer cell, such blacklisted relation with the target cell 84 may be identified and maintained at the source eNB 82 by setting isHoAllowed=FALSE and isRemoveAllowed=FALSE. Thus, if another UE later reports a blacklisted cell (e.g., the target cell 84) as a candidate for HO, the source eNB 82 does not trigger a HO.

When the target cell 84 is classified as a boomer cell, the network operator may choose to optimize or “re-configure” that target cell, for example, to minimize its unintentional coverage or overshoot. The operator may accomplish such optimization, for example, by tilt adjustment of the boomer cell's antenna(s) or by using some other configuration means. Once such optimization is performed, that target cell's boomer status may need to be removed from the source eNB's 82 NRT. In one embodiment, the boomer relation associated with the target cell 84 in the source cell's 82 NRT may be manually removed after the target cell optimization is over, as indicated at block 160.

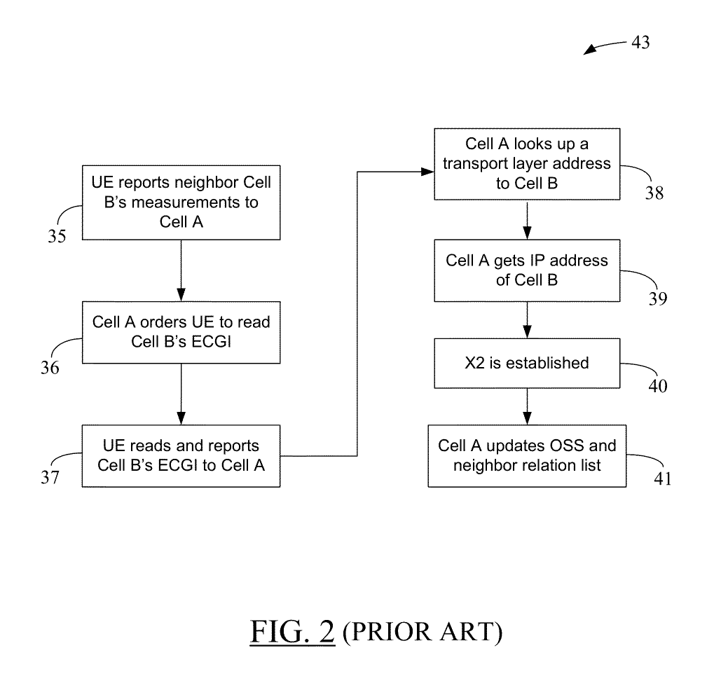

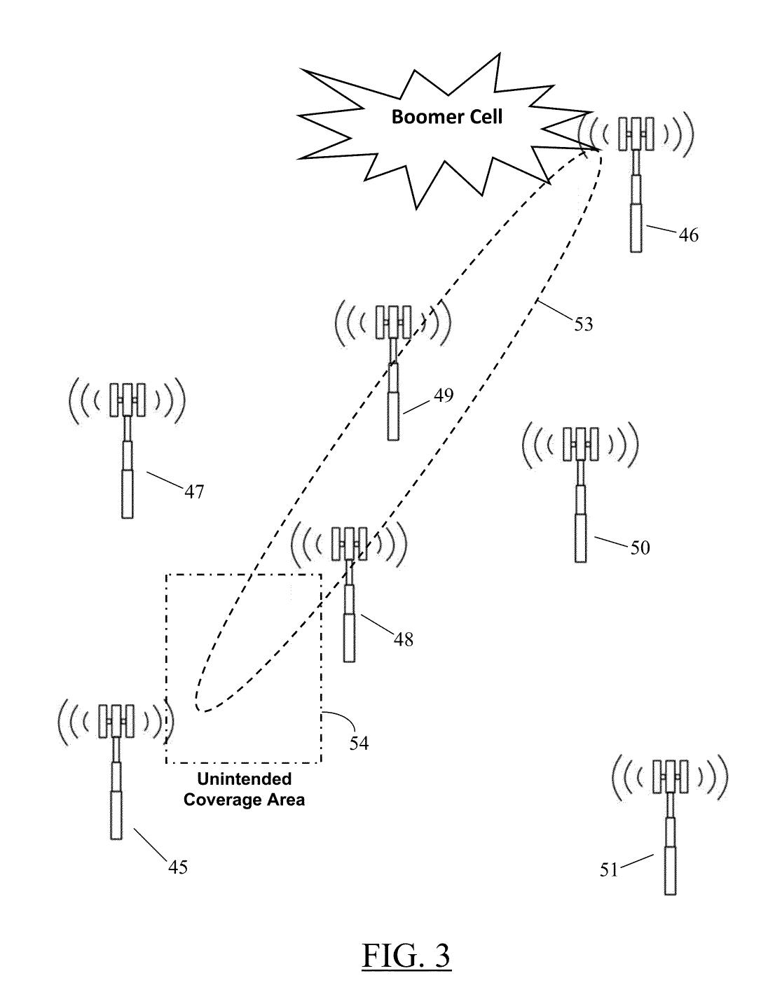

Referring to the decision block 155 in FIG. 7, if the distance and tier values are less than the set thresholds, the source eNB 82 may decide to add into its NRT this new neighbor relation to the UE-reported neighbor—i.e., the target cell 84. As part of adding such NR to its NRT, the source eNB 82 may use the UE-reported PCI and the ECGI values of the target cell 84 at blocks 137 and 149, respectively, to look up a transport layer address to the new eNB—i.e., the eNB associated with the target cell 84. The source eNB 82 may perform such look-up via a DNS look-up or via an S1 Configuration Transfer as noted at block 162 in FIG. 7 and as explained earlier in more detail with respect to blocks 38-39 in FIG. 2. If needed, the source eNB 82 may set up a new X2 interface to the target eNB 84, and may also update its neighbor relation list (or NRT) to reflect addition of the target cell 84 as a valid neighbor (block 163). Because earlier discussion of blocks 38-41 in FIG. 2 already provides more details of the actions outlined in blocks 162-163 in FIG. 7, additional discussion of blocks 162-163 in FIG. 7 is omitted for the sake of brevity.

Like FIG. 4A, the embodiment in FIG. 7 addresses a situation where a decision is to be made—e.g., by a source eNB or by an ANR function in the source eNB—to add or reject a new neighbor cell in a source cell's neighbor list depending on whether it is determined that the new neighbor is a boomer cell or not. On the other hand, like FIG. 4B, the embodiment in FIG. 8 (discussed below) addresses a situation where a decision is to be made—by the SON-OM server—whether a neighbor cell that is already defined in a source cell's NRT can be classified as a boomer cell so that it can be blacklisted in the source cell's NRT.

FIG. 8 shows an exemplary flowchart 165 depicting how a SON-OM server may classify a currently-defined neighbor relation as a boomer relation according to particular embodiments of the present disclosure. As noted before, the SON AS 91 in FIG. 5 configured by the SON-OM module 92 may be considered the SON-OM server as per one embodiment of the present disclosure. Hence, in the discussion below, the reference numeral “91” is used to refer to the “SON-OM server.” Initially, at block 167, the SON-OM server 91 may calculate the distance and tier value for each neighbor relation that is already defined in the NRT of the source eNB 82. The SON-OM server 91 may then compare the distance and tier values for each existing neighbor relation of the source cell against the earlier-mentioned pre-defined boomer classification thresholds maxDistForAnrNbr and maxTierForAnrNbr for the source cell 82 (block 169). In one embodiment, the SON-OM server may store in a memory thereof, such as the memory 192 in FIG. 9, the values for the thresholds maxDistForAnrNbr and maxTierForAnrNbr for the source eNB 82. A user 95 may provide these values as operator-defined thresholds to the SON-OM server for storage therein. In another embodiment, as noted earlier, the SON-OM server may be configured to compute the values for these thresholds for the source eNB 82. At block 171, the SON-OM server 91 may identify those neighbor cells in the source cell's NRT that satisfy the following two conditions with respect to the source eNB 82: distance>maxDistForAnrNbr and tier>maxTierForAnrNbr (block 171). When a neighbor cell is located at a distance greater than the source eNB's maxDistForAnrNbr threshold and when the tier value of the neighbor cell is greater than the maxTierForAnrNbr threshold defined for the source eNB, the SON-OM server may classify that neighbor relation as a “probable boomer cell” relation (block 173).

To further substantiate its classification at block 173—i.e., to ascertain that the probable boomer cells are indeed boomer cells, the SON-OM server 91 may schedule (e.g., through the source eNB 82) the Enhanced Cell ID (E-CID) procedure for one or more UEs attached to the source cell for traces recording on all of the probable boomer cells over a pre-defined time interval (block 175). These UEs may be the UEs reporting corresponding probable boomer cells to the source eNB 82 or receiving measurable signals from the probable boomer cells. Thus, for example, the UE 87 may be scheduled by the SON-OM module 92 to perform E-CID on the target cell 84 (assuming that the target cell 84 is already defined in the source cell's NRT as having a neighbor relation with the source cell and assuming that the SON-OM server determines the target cell 84 to be a probable boomer cell) because the UE 87 may be reporting the target cell 84 to the source eNB 82. Any other UE may be similarly scheduled as well for traces recording on the target cell 84. The traces recording (at the SON-OM server) collects the Timing Alignment (TA) information (referred to herein as “collected TA information”) specific to each probable boomer cell via UL messaging from the corresponding UE(s) performing the E-CID measurements. This collected TA information may be used by the SON-OM server to more accurately determine or verify the distance information for each probable boomer cell.

As also noted at block 175, the SON-OM server may use Performance Management (PM) counters as well to obtain statistical TA information for each probable boomer cell (e.g., the target cell 84) based on the probable boomer cell-related successful Random Access (RA) attempts by different UEs over a pre-defined time interval. In LTE, the PM counters may be referred to as Key Performance Indicators (KPIs). There may be many different types of PM counters or KPIs used by the OSS 80 to characterize the performance of the network 78 under actual operational conditions—i.e., to determine whether the network performance indeed matches its targeted quality. The KPI values may help the OSS 80 to locate potential performance bottlenecks in the network 78 and to optimize the overall performance of the network 78.

As part of the operations at block 175, the SON-OM server may combine the collected TA information and the statistical TA information for each probable boomer cell in a pre-defined proportion to create a distribution of TA samples for each probable boomer cell. For example, in one embodiment, the SON-OM server may assign a first weight to the collected TA information (thereby generating “weighted collected information”) and a second weight to the statistical TA information (thereby generating “weighted statistical TA information”) for a probable boomer cell. For a probable boomer cell, the first weight may be 50% (0.5), 60% (0.6), etc., and the corresponding second weight may be 50% (0.5), 40% (0.4), etc. For each probable boomer cell, the SON-OM server may combine the corresponding weighted collected TA information and the corresponding weighted statistical TA information to create a distribution of the TA samples for that cell.

Additionally, as noted at block 176, the SON-OM server 91 may also determine, for each probable boomer cell, the percentage of the Transport Block Size (TBS) that are power-restricted for that probable boomer cell. In one embodiment, for each probable boomer cell, the SON-OM server may use appropriate statistical PM counters to obtain Power Headroom Report (PHR) received for that probable boomer cell from one or more UEs attached to that cell. Based on the received PHR, the SON-OM server may determine the percentage of TBS that are power-restricted for the corresponding probable boomer cell. It is observed here that when a UE is far removed from a cell, but is still attached to that cell, the UE may need significantly more power to communicate with its “owner” cell. In that case, the UE may have less power headroom available. The UE's PHR report may be thus used to identify how far the radio coverage of the UE's “owner” cell extends. On the other hand, a UE may have more power headroom when the UE is attached to a nearby cell or when the UE does not need to use extra power to communicate with its “owner” cell. Because available transmit power may affect a UE's computation of TBS for the 1 ms transport block in a 10 ms LTE radio frame, the UE may have to conserve power by restricting its TBS. Thus, in one embodiment, a UE's PHR report may indicate what percentage of TBS are sent power-restricted to a probable boomer cell by that UE.

As indicated at decision block 178, the SON-OM server may perform two comparisons: (i) The SON-OM server may determine whether the percentage of TA samples (in the distribution of TA samples created at block 175) having corresponding TA values greater than the threshold “maxDistForAnrNbr” exceeds another pre-defined threshold “threshTaOver”; and (ii) the SON-OM server may also determine whether the proportion/percentage of power-restricted TBS (at block 176) exceeds yet another pre-defined threshold “threshPhrRes.” In one embodiment, the values for the parameters “threshTaOver” and “threshPhrRes” may be settable by a user (e.g., the user 95) in the SON AS 91 only—i.e., the UEs, eNBs, core network, or any other non-OSS network node or entity may not have these parameters stored or defined therein. The values of these parameters may be heuristically determined depending, for example, on iterative applications of different values of these parameters until the probable boomer cells are verified as valid boomer cells with desired accuracy.

If the SON-OM server makes the determination in the affirmative at block 178, then the corresponding target cell (i.e., the earlier-determined probable boomer cell at block 173) is now classified as a valid boomer cell as indicated at block 180. Such classification as a boomer cell would prevent the HO of a UE attached to the source cell 82 to that boomer cell as discussed earlier. As noted at block 180, the SON-OM server may also set the isHoAllowed flag in the source eNB's 82 NRT to the “FALSE” value, and the isRemoveAllowed flag in the source eNB's NRT to the “FALSE” value as well for the particular NR under consideration (i.e., the NR associated with the recently-classified boomer cell). Once these boomer cells are suitably optimized, the “blacklisted” status of their neighbor relations (in the neighbor list of the source eNB 82) can be manually removed as indicated at block 182. Because blocks 180 and 182 in FIG. 8 are similar to blocks 158 and 160, respectively, in FIG. 7, additional discussion of blocks 180 and 182 is not provided herein for the sake of brevity. The earlier discussion of blocks 158 and 160 applies to corresponding blocks 180 and 182 as well.

On the other hand, if the SON-OM server makes the determination in the negative at block 178—i.e., if either or both of the conditions at block 178 are not satisfied, then, as indicated at block 184, the SON-OM server may not take any immediate action for the corresponding target cell—i.e., the probable boomer cell determined earlier at block 173. Rather, in one embodiment, the SON-OM server may continue to perform periodic monitoring of all those probable boomer cells that fail the determination at block 178, as noted at block 184. As part of such periodic monitoring, the SON-OM server may repeat the process from block 175 onwards in FIG. 8, as indicated by arrow 185. The SON-OM server may continue to monitor the TA and PHR criteria for these probable boomers based on user defined conditions for continued monitoring and eventual conclusion depending, for example, on elapse of a pre-defined time period or execution of a pre-determined number of monitoring-related iterations of the actions at blocks 175-176 and 178 in FIG. 8.

FIG. 9 is a block diagram of an exemplary SON application server (e.g., the SON AS 91 in FIG. 5) according to one embodiment of the present disclosure. As mentioned before, the SON AS 91 in FIG. 9 may be configured as a SON-OM server to perform the operations illustrated in the exemplary embodiments of FIGS. 4B and 8. Thus, in one embodiment, the SON AS 91 may include a processor 190 that may be “configured” in hardware and in software, if necessary, to accomplish the boomer cell classification aspects of the present disclosure. In FIG. 9, the processor 190 is shown coupled to a system memory 192, a peripheral storage unit 194, one or more input devices 195, one or more output devices 196, and an interface unit 198. In some embodiments, the SON AS server 91 may include more than one instance of the devices 190, 192, 194-196, and 198 shown in FIG. 9. Some examples of the SON AS server 91 may include a computer system (desktop or laptop), a machine-to-machine (M2M) communication unit, a workstation, or any other type of computing or data processing unit. In various embodiments, the SON AS 91 may be configured as a rack-mountable server system, a standalone system, or in any other suitable form factor. In some embodiments, the SON AS 91 may be configured as a client of some other server system (not shown). As mentioned earlier, SON AS 91—as configured by the SON-OM module 92—may be implemented as part of the OSS 80 or as an entity that is not part of the OSS 80 but coupled to the OSS 80 (and possibly to the carrier network 78 as well) to receive appropriate information from the OSS 80 (e.g., trace data, ANR configuration data, etc.) for further processing as per the teachings of the present disclosure.

In particular embodiments, the processor 190 may include more than one core, and/or the SON AS 91 may include more than one processor (e.g., in a distributed processing configuration). When the SON AS 91 is a multiprocessor system, there may be more than one instance of the processor 190 or there may be multiple processors (not shown) coupled to the processor 190.

In various embodiments, the system memory 192 may comprise any suitable type of non-transitory memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), Rambus® DRAM, flash memory, and of various types of Read Only Memory (ROM), etc. In one embodiment, the system memory 192 may include multiple discrete banks of memory controlled by discrete memory interfaces in the embodiments of the processor 190 that provide multiple memory interfaces. Also, in some embodiments, the system memory 192 may include multiple different types of memory, as opposed to a single type of memory. In one embodiment, the system memory 192 may store the entire program code or at least a relevant, server-related portion of the program code for the SON-OM module 92. In the latter case, a base station-related portion of the program code may be stored in an eNB-based SON-OM module such as, for example, the SON-OM module 212. In one embodiment, the program code of the SON-OM module 92 may be executed by the processor 190 and, upon execution, the SON-OM program code may configure the SON AS 91 to function as the earlier-described SON-OM server to perform validations of current neighbor relations for classification of boomer cells as per the flowchart 165 in FIG. 8. In another embodiment, the SON-OM module 92, upon execution by the processor 190, may also configure the SON AS 91 to perform the operations illustrated in FIG. 4B.

The peripheral storage unit 194, in various embodiments, may include support for various non-transitory storage media such as, for example, magnetic, optical, magneto-optical, or solid-state storage media like hard drives, optical disks (such as CDs or DVDs), non-volatile RAM devices, etc. In some embodiments, the peripheral storage unit 194 may include more complex storage devices/systems such as disk arrays (which may be in a suitable RAID (Redundant Array of Independent Disks) configuration) or Storage Area Networks (SANs), which may be coupled to the processor 190 via a standard Small Computer System Interface (SCSI), a Fibre Channel interface, a Firewire® (IEEE 1394) interface, or another suitable interface.

In particular embodiments, the input devices 195 may include standard input devices such as a computer keyboard, mouse or other pointing device, a touchpad, a joystick, or any other type of data input device. The output devices 196 may include a graphics/display device, a computer screen, an audio speaker, an alarm system, or any other type of data output or process control device. In some embodiments, the input device(s) 195 and the output device(s) 196 may be coupled to the processor 190 via appropriate I/O and peripheral interface(s) (not shown).

In one embodiment, the interface unit 198 may communicate with the processor 190 to enable the SON AS 91 to couple to the database server 90 and SON PORTAL 94. In another embodiment where the SON AS 91 is not part of the OSS 80, the interface unit 198 may enable the SON AS 91 to communicate with the OSS 80, the carrier network 78, and/or a core network (not shown), if needed. In another embodiment, the interface unit 198 may be absent altogether. The interface unit 198 may include any suitable devices, media and/or protocol content for connecting the system 91 to other devices or entities—whether through wired or wireless means, and whether within a single network or over a combination of networks, including the Internet.

In one embodiment, the SON AS may include an on-board power supply unit 199 to provide electrical power to various system components illustrated in FIG. 9. The power supply unit 199 may receive batteries or may be connectable to an AC electrical power outlet. In one embodiment, the power supply unit 199 may convert solar energy into electrical power.

FIG. 10 depicts an exemplary block diagram of a base station (e.g., the base station 82 in FIG. 5) that may function as a network entity according to one embodiment of the present disclosure. In one embodiment, the base station 82 may be an eNB. In one embodiment, the eNB 82 may be configured to perform various functionalities discussed earlier with reference to FIGS. 4A and 7. Thus, for example, the eNB 82 may be configured to perform the boomer cell classification based on its communication with the SON-OM server 91 and the UE 87 as per the embodiments of FIGS. 4A and 7. In that regard, the eNB 82 may include a baseband processor 200 to provide radio interface with the wireless devices (e.g., the UE 87 or other mobile devices operating in the carrier network 78 in FIG. 5) via eNB's Radio Frequency (RF) transceiver unit 202 coupled to the eNB's antenna unit 204. The transceiver unit 202 may include RF transmitter 206 and RF receiver 207 units coupled to the eNB's antenna unit 204.

In one embodiment, the processor 200 may receive transmissions (e.g., UL signals, neighboring cell measurement reports including neighboring cell's PCI, ECGI, etc.) from the UEs (e.g., UE 87 in FIG. 5) via the combination of the antenna unit 204 and the receiver 207, whereas eNB's transmissions (e.g., scheduling instructions, handover information, etc.) to the UEs (e.g., the UE 87 in FIG. 5) may be carried out via the combination of the antenna unit 204 and the transmitter 206.

The processor 200 may be configured (in hardware and/or software) to perform the boomer cell classification based on distance and tier information per the teachings of the present disclosure. In that regard, the processor 200 may include a processing unit 210 having a SON-OM module 212 to perform the boomer cell identification as per the teachings of the present disclosure. In one embodiment, the SON-OM module 212 may be a separate unit coupled to the processing unit 210 and/or the RF transceiver 202 to receive various (neighboring cell) measurement reports from the UEs and to perform HO-related transmissions to UEs. In another embodiment, various neighbor list creation (through ANR) and boomer cell classification aspects discussed earlier with reference to exemplary FIGS. 4A and 7 may be implemented using the module 212 in combination with the processing unit 210, the RF transmitter 206, the RF receiver 207, the antenna unit 204, the scheduler 214 (discussed later below) and the memory 216 (which may be part of the processor 200 as well). Some or all the program code for the module 212 may reside in the memory 216 and executed by the processing unit 210. In one embodiment, the module 212 may include a base station-related portion of the program code for the SON-OM module 92, thereby allowing the eNB 82 to interact with the SON AS 91. The program code for the module 212, when executed by the processing unit 210, may configure the eNB 82 or the eNB-based ANR functionality to perform eNB-related tasks shown in FIGS. 4A and 7. In another embodiment, the eNB-based SON-OM module 212 may itself host the ANR function suitably modified to perform these tasks.

Thus, in one embodiment, the eNB 82 may be configured by the execution of the program code of the SON-OM module 212 to perform the pre-HO screening of an HO candidate cell based on distance and tier as per the flowchart 57 in FIG. 4A and the flowchart 135 in FIG. 7. For example, the module 212 may receive initial neighbor cell PCI measurements from a UE, order the UE to read ECGI for the target cell, perform the distance and tier value comparisons to determine whether a UE-reported target cell is a boomer cell or not, etc. The SON-OM module 212 may also create (if not already created/stored) a neighbor list (not shown) in the memory 216 and may then initiate the ANR procedure to build or maintain the neighbor list based on measurement reports received from the UE. The SON-OM module 212 may remain in communication with the processing unit 210. Communications from UEs may be received (via the antenna unit 204 and the receiver 207) and stored in the memory 216 for further processing by the processing unit 210 and the SON-OM module 212. Other arrangements to implement the functionality of the SON-OM module 212 in the base station 82 may be devised as well. For example, in one embodiment, the functionality of the module 212 may be implemented in an external component such as, for example, a BSC or a gateway/control node (not shown). Alternatively, all of the functionalities of the module 212 may be performed by the processing unit 210 (e.g., when the module 212 is an integral part of the processing unit 210 as shown, for example, in the embodiment of FIG. 10).

The processing unit 210 may be in communication with the memory 216 to process and store relevant information for the cell (e.g., identities of UEs operating within the cell, a neighbor list for the cell created using the ANR procedure, neighbor cell measurement reports received from UEs, etc.). A scheduler (e.g., the scheduler 214 in FIG. 10) may be part of the eNB's 82 processor 200 and may provide the scheduling decisions for eNB-attached UEs based on a number of factors such as, for example, QoS (Quality of Service) parameters, UE buffer status, uplink channel feedback report received from UEs, UE capabilities, etc. The scheduler 214 may have the same data structure as a typical scheduler in an eNB in an LTE system. In one embodiment, the eNB 82 may include separate UL and DL schedulers (not shown in FIG. 10) as part of its baseband processor 200. The processor 200 may also provide additional baseband signal processing (e.g., mobile device registration, channel signal information transmission, radio resource management, etc.) as required.

The eNB 82 may further include a timing and control unit 218 and a core network interface unit 220 as illustrated in FIG. 10. The control unit 218 may monitor operations of the processor 200 and the network interface unit 220, and may provide appropriate timing and control signals to these units. The interface unit 220 may provide a bi-directional interface for the eNB 82 to communicate with its core network and, if applicable, to an OSS (e.g., the OSS 80 in FIG. 5) to facilitate administrative and call-management functions for mobile subscribers operating in the corresponding carrier network (e.g., the carrier network 78 in FIG. 5) and attached to the eNB 82.

Some or all of the functionalities described above with reference to FIGS. 4A and 7 as being provided by a base station or another network entity having similar functionality (such as a wireless access node/point, a mobile base station, a base station controller, a node B, an enhanced node B, and/or any other type of mobile communications node) may be provided by the processing unit 210 (with processing support from the module 212, as needed) executing instructions stored on a computer-readable data storage medium, such as the memory 216 shown in FIG. 10.

It will be appreciated that the flow charts in FIGS. 4A-4B and 7-8 represent various processes which may be substantially performed by a corresponding processor (e.g., the processor 190 in FIG. 9, and the processing unit 210 in FIG. 10). The processor may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. The processor may also employ distributed processing in certain embodiments.

Some or all aspects of the methodology provided herein (related to classification of boomer cells based on distance and tier information) may be implemented in a computer program, software, firmware, or microcode incorporated in a non-transitory, computer-readable storage medium (e.g., the memory 192 in FIG. 9 or the memory 216 in FIG. 10) for execution by a general purpose computer or a processor (e.g., the processor 190 in FIG. 9 or the processing unit 210 in FIG. 10). In particular embodiments, such computer-readable medium may be part of the peripheral storage 194 in the embodiment of FIG. 9, or may be part of a processor's internal memory (e.g., the internal memory (not shown) of the processing unit 210 in FIG. 10). A processor (e.g., the processor 190 in FIG. 9 or the processing unit 210 in FIG. 10) may execute instructions stored on a related computer-readable medium to carry out the software-based processing. Examples of computer-readable storage media include a Read Only Memory (ROM), a Random Access Memory (RAM), a digital register, a cache memory, a cloud-based storage system, semiconductor memory devices, magnetic media such as internal hard disks, magnetic tapes and removable disks, magneto-optical media, and optical media such as CD-ROM disks and Digital Versatile Disks (DVDs).

Alternative embodiments of the base station 82 and the SON AS 91 may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features and elements. As mentioned before, the functions of the eNB 82 and the SON AS 91 may be provided through the use of hardware (such as circuit hardware) and/or hardware capable of executing software/firmware in the form of coded instructions or microcode stored on a computer-readable medium (mentioned above). Thus, such functions (in FIGS. 4A-4B and 7-8) and illustrated functional blocks (in FIGS. 9-10) are to be understood as being either hardware-implemented and/or computer-implemented, and thus machine-implemented.

The foregoing describes a system and method to automatically classify a neighbor cell as a boomer cell by improving the ANR system at a source cell to make a decision whether to add or reject the neighbor (target) cell suggested by a UE as a valid neighbor of the source cell. Such decision may be based on (i) the distance between the source and the target cells, and (ii) the tier value indicating the number of layers of cell sites between the source and the target cells. The distance and tier information may be provided by a SON-OM server to automatically classify a target cell as a boomer cell and to exclude such boomer cells from a neighbor list of a source cell. For neighbors which are already defined and existing in a source cell's neighbor list, the SON-OM server can perform a validation whether these neighbors are boomer cells or not. Such validation may be based on the above-mentioned distance and tier calculation as well as on correlation with TA values and PHR criteria. Once a neighbor cell is classified as a boomer cell, it can be automatically eliminated from the neighbor list without the manual intervention of the operator. All handovers to that boomer cell can be prevented as well to improve interference management and resource utilization in the network.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of classifying a target cell to determine whether a User Equipment (UE) associated with a source cell is to be handed off to the target cell by an evolved Node B (eNB) in a wireless system, wherein the eNB provides Radio Frequency (RF) coverage to the UE associated with the source cell, and wherein the method comprises performing the following using the eNB:
first determining that the target cell is not defined as a neighbor of the source cell in a Neighbor Relations Table (NRT) of the source cell;
in response to the first determining that the target cell is not defined in the NRT of the source cell, querying a Self Organizing Network-Optimization Manager (SON-OM) server to provide information about a distance between the source cell and the target cell and a tier value indicating a number of layers of cell sites between the source cell and the target cell;
receiving the distance and the tier value information from the SON-OM server;
second determining that the distance is greater than a first threshold and the tier value is greater than a second threshold; and
classifying the target cell as a boomer cell in response to the second determining.

2. The method of claim 1, wherein the first determining includes performing the following using the eNB:
receiving a measurement report from the UE containing a Physical Cell ID (PCI) of the target cell in the wireless system from which RF signals are also received by the UE; and
checking the NRT using the received PCI of the target cell to determine that the target cell is not defined in the NRT.

3. The method of claim 1, wherein the querying includes using, by the eNB, an Automatic Neighbor Relation (ANR) function to query the SON-OM server through a SON Configuration Transfer Information Element (IE).

4. The method of claim 1, wherein the method further comprises performing the following using the eNB:
preventing a handoff of the UE to the target cell in response to the classifying the target cell as the boomer cell.

5. The method of claim 4, wherein the preventing includes creating, by the eNB, a neighbor relation to the target cell indicating the target cell as the boomer cell.

6. The method of claim 1, wherein the method further comprises performing the following using the eNB:
receiving a first value for a first flag associated with the NRT, wherein the first value allows the eNB to blacklist the target cell in the NRT of the source cell to prevent triggering of a handoff of the UE to the target cell; and
receiving a second value for a second flag associated with the NRT, wherein the second value allows the eNB to prevent removal of a blacklisted status of the target cell from the NRT.

7. A network entity in a cellular network for classifying a target cell to determine whether a mobile device associated with a serving cell is to be handed over to the target cell in the cellular network, wherein the network entity comprises:
a transceiver for wirelessly communicating with the mobile device and for providing Radio Frequency (RF) coverage to the mobile device in the serving cell;
a memory for storing program instructions; and
a processor coupled to the memory and the transceiver and configured to execute the program instructions, which, when executed by the processor, cause the network entity to perform the following:
determine that the target cell is not defined as a neighbor of the serving cell in a Neighbor Relations Table (NRT) of the serving cell;
in response to the determination that the target cell is not defined in the NRT of the source cell, query a Self Organizing Network (SON) server to provide information about a distance between the serving cell and the target cell and a tier value indicating a number of layers of cell sites between the serving cell and the target cell;
receive the distance and the tier value information from the SON server;
further determine that the distance is greater than a first threshold and the tier value is greater than a second threshold; and
classify the target cell as a boomer cell for the serving cell to prevent the handover of the mobile device to the target cell.

8. The network entity of claim 7, wherein the network entity is one of:
a Radio Base Station (RBS);
a Base Station Controller (BSC);
a Radio Network Controller (RNC); and
an evolved Node B (eNodeB).

9. The network entity of claim 7, wherein the program instructions, when executed by the processor, cause the network entity to further perform the following:
for the serving cell, create a neighbor relation to the target cell indicating the target cell as the boomer cell;
receive a first value for a first parameter associated with the NRT, wherein the first value allows the network entity to blacklist the target cell in the NRT to prevent triggering of the handover of the mobile device to the target cell; and
receive a second value for a second parameter associated with the NRT, wherein the second value allows the network entity to prevent removal of a blacklisted status of the target cell from the NRT.

10. A non-transitory, computer-readable medium containing program instructions, which, when executed by a computer system, cause the computer system to perform the operations comprising:
calculating a first distance between a source cell and a first target cell in a cellular network and a first tier value indicating a first number of layers of cell sites between the source cell and the first target cell in the cellular network, wherein the first target cell is defined as having a neighbor relation with the source cell;
determining that the first distance is greater than a first threshold and the first tier value is greater than a second threshold;
creating a distribution of Timing Alignment (TA) samples for the first target cell;
further determining a proportion of Transport Block Size (TBS) that are power-restricted for the first target cell;
ascertaining that a percentage of the TA samples having corresponding TA values greater than the first threshold exceeds a third threshold and that the proportion of power-restricted TBS exceeds a fourth threshold; and
classifying the first target cell as a boomer cell in response to the ascertaining, thereby preventing a handoff of a User Equipment (UE) associated with the source cell to the first target cell.

11. The computer-readable medium of claim 10, wherein the program instructions, upon execution by the computer system, cause the computer system to further perform the following operations as part of the creating the distribution of the TA samples:
generating collected TA information by collecting the first target cell-specific TA information over a first pre-defined time interval from the UE via Uplink (UL) messaging;
using Performance Management (PM) counters to obtain statistical TA information for the first target cell based on the first target cell-related successful Random Access (RA) attempts by different UEs over a second pre-defined time interval; and
combining the collected TA information and the statistical TA information in a pre-defined proportion to create the distribution of the TA samples.

12. The computer-readable medium of claim 11, wherein the program instructions, upon execution by the computer system, cause the computer system to further perform the following operations as part of the combining the collected TA information and the statistical TA information:
assigning a first weight to the collected TA information, thereby generating weighted collected TA information;
assigning a second weight to the statistical TA information, thereby generating weighted statistical TA information; and
combining the weighted collected TA information and the weighted statistical TA information to create the distribution of the TA samples.

13. The computer-readable medium of claim 11, wherein the program instructions, upon execution by the computer system, cause the computer system to further perform the following operation as part of the generating the collected TA information:
scheduling Enhanced Cell Identity (E-CID) for the UE for traces recording on the first target cell over the first pre-defined time interval, wherein the traces recording allows the computer system to collect the first target cell-specific TA information from the UE via the UL messaging.

14. The computer-readable medium of claim 10, wherein the program instructions, upon execution by the computer system, cause the computer system to further perform the following operations as part of the further determining the proportion of TBS:
using statistical Performance Management (PM) counters to obtain Power Headroom Report (PHR) received for the first target cell from one or more UEs attached to the first target cell; and
based on the received PHR, determining the proportion of power-restricted Transport Block Size (TBS) for the first target cell.

15. The computer-readable medium of claim 10, wherein the program instructions, upon execution by the computer system, cause the computer system to further perform the following operations:
assigning a first value to a first flag, wherein the first value allows the computer system to blacklist the neighbor relation between the source cell and the first target cell to prevent triggering of the handoff of the UE from the source cell to the first target cell; and
assigning a second value to a second flag, wherein the second value allows the computer system to prevent removal of a blacklisted status of the neighbor relation between the source cell and the first target cell.

16. A computer system, comprising:
a memory for storing program instructions; and
a processor coupled to the memory and configured to execute the program instructions, which, when executed by the processor, cause the computer system to perform the following:
calculate a first distance between a source cell and a first target cell in a cellular network and a first tier value indicating a first number of layers of cell sites between the source cell and the first target cell in the cellular network, wherein the first target cell is defined as having a neighbor relation with the source cell;
determine that the first distance is greater than a first threshold and the first tier value is greater than a second threshold;
create a distribution of Timing Alignment (TA) samples for the first target cell;
further determine a proportion of Transport Block Size (TBS) that are power-restricted for the first target cell;
ascertain that a percentage of the TA samples having corresponding TA values greater than the first threshold exceeds a third threshold and that the proportion of power-restricted TBS exceeds a fourth threshold; and
classify the first target cell as a boomer cell in response to the ascertaining, thereby preventing a handoff of a User Equipment (UE) associated with the source cell to the first target cell.

17. The computer system of claim 16, wherein the program instructions, upon execution by the processor, cause the computer system to further perform the following:
receive a query from an evolved Node B (eNB) to provide to the eNB a second distance between the source cell and a second target cell in the cellular network and a second tier value indicating a second number of layers of cell sites between the source cell and the second target cell in the cellular network, wherein the second target cell is not defined as a neighbor of the source cell in a Neighbor Relations Table (NRT) of the source cell; and
send the second distance and second tier value to the eNB in response to the query therefrom.

18. A wireless system comprising:
an evolved Node B (eNB) that is configured to perform the following:
provide Radio Frequency (RF) coverage over a serving cell associated with the eNB,
further provide RF coverage to a first User Equipment (UE) associated with the serving cell in the wireless system,
determine that a first target cell reported by the first UE is not defined as a neighbor of the serving cell in a Neighbor Relations Table (NRT) of the serving cell,
in response to the determination that the first target cell is not defined in the NRT of the serving cell, send a query to a computer system to request information about a first distance between the serving cell and the first target cell and a first tier value indicating a first number of layers of cell sites between the serving cell and the first target cell,
receive the first distance and the first tier value information from the computer system,
further determine that the first distance is greater than a first threshold and the first tier value is greater than a second threshold, and
classify the first target cell as a first boomer cell for the serving cell to prevent the handover of the first UE to the first target cell; and
the computer system that is in communication with the eNB and configured to perform the following:
receive the query from the eNB,
calculate the first distance and the first tier value, and
send the first distance and the first tier value to the eNB.

19. The wireless system of claim 18, wherein the computer system is configured to further perform the following:
calculate a second distance between the serving cell and a second target cell and a second tier value indicating a second number of layers of cell sites between the serving cell and the second target cell in the wireless system, wherein the second target cell is defined as having a neighbor relation with the serving cell;
determine that the second distance is greater than a third threshold and the second tier value is greater than a fourth threshold;
create a distribution of Timing Alignment (TA) samples for the second target cell;
further determine a proportion of Transport Block Size (TBS) that are power-restricted for the second target cell;
ascertain that a percentage of the TA samples having corresponding TA values greater than the third threshold exceeds a fifth threshold and that the proportion of power-restricted TBS exceeds a sixth threshold; and
classify the second target cell as a second boomer cell in response to the ascertaining, thereby preventing a handover of a second UE associated with the serving cell to the second target cell.

20. The wireless system of claim 18, wherein the computer system comprises a Self Organizing Network-Optimization Manager (SON-OM) server.
